(19) United States
(12) Patent Application Publication
(10) Pub. No.: US 2022/0340703 A1
(43) Pub. Date: Oct. 27, 2022

(54) HYBRIDIZED GRAFT COPOLYMERS IN COATING AND INK COMPOSITIONS

(71) Applicant: Penn Color, Inc., Doylestown, PA (US)

(72) Inventors: Namgoo Kang, Doylestown, PA (US); Kenneth Myers, Schwenksville, PA (US); Andrew Sandt, Eagleville, PA (US); Mark D. Adams, Hellertown, PA (US); William C. Miles, Collegeville, PA (US)

(73) Assignee: Penn Color, Inc., Doylestown, PA (US)

(21) Appl. No.: 17/761,024

(22) PCT Filed: Sep. 25, 2020
(86) PCT No.: PCT/US2020/052725

§ 371 Date: Mar. 16, 2022

Related U.S. Application Data
(60) Provisional application No. 62/905,853, filed on Sep. 25, 2019.

(51) Int. Cl. C08F 285/00; C08F 220/18; C08F 2/48; C08F 2/54

(52) U.S. Cl. CPC C08F 285/00; C08F 220/1804; C08F 2/48; C08F 2/54; C09D 11/101

(57) ABSTRACT

The present disclosure generally related to photopolymerizable liquid compositions containing hybridized graft copolymers, reactive diluents and optionally oligomers, photoinitiators, colorants and other additives.

### CROSS-REFERENCE TO RELATED APPLICATIONS

This application claims the benefit of priority to U.S. Provisional Patent Application No. 62/905,853 filed Sep. 25, 2019, the disclosure of which is hereby incorporated by reference in its entirety.

### FIELD

The present disclosure generally relates to compositions of photopolymerizable liquids, such as those curable by visible, ultraviolet or electron beam light, that contain graft polymer resins that provide enhanced solvent resistance, enhanced scratch resistance, enhanced adhesion to various substrates and between similar and dissimilar substrates and easier removal upon entry into the recycle stream.

### BACKGROUND

Coatings are found in just about every walk of everyday life. From automotive paints to digital signage, coatings are used to differentiate in many ways. Sometimes, that differentiation has to do with achieving a desired aesthetic look to differentiate a product or brand to a consumer. Sometimes that differentiation has to do with a functional benefit, such as protecting a surface from mechanical (scratches) or environmental (acid rain, UV radiation, corrosion) conditions. Coatings can be provided in different forms, including powder, solvent-borne, water-borne or photopolymerizable coatings.

Each coating form has advantages and disadvantages depending on the system used. For example, water-borne coatings are advantageous because they typically contain small to no amounts of volatile organic compounds (VOCs). But they are disadvantageous because they can generate foam, take a long time to dry and/or cure, and often have poor chemical resistance. Solvent-borne systems are typically fairly easy to handle but can still take an extended time to cure and include VOCs. Powder coatings are excellent from a VOC and environmental standpoint but require specific processing temperatures and are unable to be used on some substrates (i.e. PVC, which can distort at 140° F.). Photopolymerizable (also referred to herein as energy curable or radiation curable) coatings have several advantages, in that they provide extremely fast cure, contain low or no VOCs and are easy to use. But there are drawbacks, which include difficulty of curing pigmented coatings, higher raw material costs, adhesion failures on metals and plastics, skin irritation from some reactive diluents, malodor, and are difficult to remove when desired such as, for example, in a recycling process.

The mechanism by which a photopolymerizable liquid formulation forms a film is relatively well known in the field (Schwalm, UV Coatings: Basics, Recent Developments and New Applications, Elsevier Publications, 2007). Briefly, a formulation consisting of monomers, oligomers, photoinitiators (for UV, but not necessarily for electron beam curing) and a series of other additives (surfactants, adhesion promoters, colorants, etc.) is deposited onto a substrate and exposed to a form of light radiation. In the case of UV curable formulations, the photoinitiator generates a radical that starts a chemical reaction (initiation). The radical reacts with a functional group on either the monomer or oligomer, which then transfers the radical to that molecule, which then reacts with another functional group on another monomer or oligomer (propagation and chain transfer). At some point, two radical-containing molecules come into contact, which ends the reaction (termination), but the resulting material has very different properties than the initial formulation as it now consists of polymeric units rather than small molecule monomers and oligomers. This has the advantage of being an extremely rapid, 100% solids reaction with application in many different coatings and ink spaces.

One aspect critical to photopolymerizable liquid formulations is adhesion. In particular, adhesion to certain metals and plastics can be difficult or impossible for photopolymerizable coatings. A common solution to enhance adhesion is some sort of pre-treatment (corona, oxygen plasma, flame treatment, etc.) prior to application of the coating. These pre-treatments modify the surface energy of a substrate to enable or enhance wetting of the substrate, often to increase the bonding of the coating to the surface. Disadvantages of pre-treatment are that those methods are not always effective for all surfaces and can give good initial bonding that is reduced over time. Additionally, some pre-treatment methods (flame treatment as an example) introduce hazards to the production environment, particularly when a customer is using solvent-borne coatings in the same facility that have flammability concerns associated with them.

For coatings where photopolymerizable coatings between bonded layers are desired, oftentimes the coating prevents adhesion between the bonded layers. Luxury vinyl tile (LVT) is a good example, where a printed photopolymerizable coating between a vinyl substrate and a laminated wear layer can prevent good bonding between the layers, preventing their use due to premature failure of the article at the interface of the substrate and the ink or the wear layer and the ink. Because photopolymerizable coatings are thermosets (i.e., not able to be thermally bonded after curing), they often are replaced with solvent-borne systems that can be used as a thermal tie-layer. Adhesion of photopolymerizable coatings in digital inks can also be an issue. The reason is that digital inks typically require low viscosities (3-30 cP at 25° C.) to jet properly, and so the amount or type of binder that is formulated into these coatings is not sufficient for adequate adhesion to the desired substrate.

To address many of these adhesion challenges, formulators are often forced to use materials specific for the substrate and the application. Often these materials are expensive in comparison to more commodity materials and introduce other trade-offs. Examples would be incorporation of surfactants and adhesion promoters. Surfactants increase the ability of a coating formulation to wet out a surface. This provides more surface contact of the coating to the surface, thus increasing adhesion. But disadvantages to surfactants are that they tend to increase foam generation, can often migrate within the cured coating and can impact chemical resistance, particularly to moisture. Adhesion promoters can be used to generate a chemical bond between the coating and the surface. This gives significantly improved adhesion but also has drawbacks including that it is extremely substrate specific (i.e., silane chemistry for glass) and also is very difficult to remove after cure.

Another aspect of a coating is the appearance, which is important for both aesthetic and functional reasons. From an aesthetic standpoint, color is often added to photopolymerizable coatings to provide graphics that appeal to consumers, warn of hazards associated with a particular item, or communicate important information necessary for use. From a functional standpoint, color is often used to provide a desired level of opacity or transparency necessary for an application. An example where high transparency is desirable would be reflective signage, where the reflective film underneath the coating must shine through the colored coating that is applied afterwards. An example where high opacity is desirable would be a white basecoat designed to provide high contrast between a clear plastic layer and a colored ink that will be affixed to the basecoat. In this case, the higher the opacity of the basecoat, the more the colored graphic will stand out compared to the plastic upon which it is printed.

Depending on the color that is desired, different wavelengths of light are being reflected and adsorbed. This can significantly affect the quality and consistency of the cure, particularly with high adsorbing (i.e. carbon black) or highly reflective (i.e. titanium dioxide, TiO2) pigments. This reduction in cure quality can lead to losses in adhesion, scratch resistance and other important performance properties. In these cases, often coating thickness or pigment loading must be reduced to allow for complete and uniform cure. This issue can also be addressed in the field using an electron beam (E-Beam) rather than a UV light as the source of radiation. However, E-Beam curtain equipment is far more expensive than UV curing equipment and so often is not economical. Additionally, colorants are considered contaminants in the recycle stream. If coatings are applied that are robust enough to withstand adhesion and abrasion requirements, they end up being very difficult or impossible to remove and can end up contaminating clear plastic in the recycle stream. If coatings are formulated to be removed easily during recycle, they do not come off as a film and end up coloring the wastewater, adding an extra step of cleaning the wastewater following removal from the package or container.

Some performance aspects of a coating are scratch resistance, chemical resistance and hardness. These are often achieved through increasing the cross-link density of the cured coating. Often this is achieved by using base materials (monomers and oligomers) that have multiple functional sites for reactions to take place, which increases the cross-link density and thus, the desired properties. However, this increased cross-link density can significantly reduce the flexibility and elongation of the coating.

Thus, there is a need for photopolymerizable formulations that can provide excellent performance properties, including but not limited to substrate adhesion, scratch resistance and chemical resistance. There is also a need for photopolymerizable formulations that can be applied without substrate pre-treatment and onto multiple substrates with the same formulation. There is also a need for photopolymerizable formulations that provide strong adhesion between two surfaces of dissimilar surface energy. Further, there is a need for photopolymerizable formulations that provide excellent performance properties but allow for easy removal using treatments common in post-consumer recycle facilities without contaminating the wastewater at the facility.

### SUMMARY

The present disclosure provides compositions that meet the aforementioned needs. In one aspect, disclosed herein is a photopolymerizable liquid composition comprising: at least one reactive diluent monomer; a hybridized graft copolymer dissolved in the at least one reactive diluent monomer, wherein the hybridized graft copolymer comprises: (a) a hydrophobic functional polymeric backbone, wherein the backbone comprises (i) an acrylate polymer, an alkylacrylate polymer, a siloxane polymer, a olefin polymer, a functional vinyl polymer, or a mixture of these functionalities, wherein the backbone has an average molecular weight (Mn) of from about 3,000 to about 200,000 g/mol; and b) a plurality of hydrophilic polymeric side chains attached to the hydrophobic functional polymeric backbone, wherein the hydrophilic polymeric side chains comprise a polymerization product of at least one polymerizable unsaturated monomer and a polymerizable amine-containing unsaturated monomer; optionally, at least one colorant selected from the group consisting of a dye and a pigment; optionally, at least one oligomer; and optionally, at least one photoinitiator.

In another aspect, disclosed herein is a method of making a photopolymerizable liquid composition comprising: providing at least one reactive diluent monomer; dissolving a solid form of a hybridized graft copolymer in the at least one reactive diluent monomer, wherein the hybridized graft copolymer comprises: (a) a hydrophobic functional polymeric backbone, wherein the backbone comprises (i) an acrylate polymer, an alkylacrylate polymer, a polysiloxane polymer, a polyolefin polymer, a functional polyvinyl polymer, or a mixture of these functionalities, wherein the backbone has an average molecular weight (Mn) of from about 3,000 to about 100,000 g/mol; and b) a plurality of hydrophilic polymeric side chains attached to the hydrophobic functional polymeric backbone, wherein the hydrophilic polymeric side chains comprise a polymerization product of at least one polymerizable unsaturated monomer and a polymerizable amine-containing unsaturated monomer; optionally adding at least one colorant selected from the group consisting of a dye and a pigment; optionally adding at least one oligomer; and optionally adding at least one photoinitiator.

These embodiments can be used alone or in combinations with each other.

### BRIEF DESCRIPTION OF THE DRAWINGS

FIG. 1 is a photograph showing a comparison of the scratch resistance of a prior art Control composition (left) versus a composition of the present disclosure (Example 4) (right) using an “H” pencil;

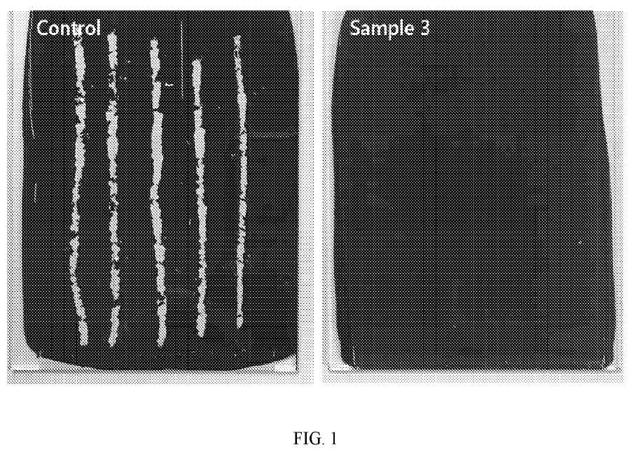

FIG. 2 is a photograph showing a comparison of the solvent resistance of a prior art Control sample (left) versus a composition of the present disclosure of Example 5 (right);

FIG. 3 is a photograph showing a comparison of cross-cut tape adhesion test results of a prior art composition versus compositions disclosed herein as detailed in Example 6;

FIG. 4 shows a series of digital prints of a prior art control ink composition (left) versus an ink composition disclosed herein as detailed in Example 7;

FIG. 5 is a photograph showing adhesion results on a PET, aluminum, and steel surface for a prior art control composition versus a composition as disclosed herein as detailed in Example 7; and

FIG. 6 is a photograph showing a comparison of the recyclability of a prior art control composition versus a composition disclosed herein as detailed in Example 8.

### DETAILED DESCRIPTION

Hereinafter, embodiments of the present disclosure (hereinafter, referred to as “embodiments”) will be described in detail. The present disclosure, however, is not limited to these embodiments, and various modifications are possible without departing from the spirit of the present disclosure.

The present disclosure relates to photopolymerizable liquid formulations containing a hybridized graft copolymer as described below. These formulations can be deposited as a coating and cured using visible, UV or electron beam radiation. In some embodiments, the addition of the hybridized graft copolymer imparts improved adhesion to multiple types of substrates. In some embodiments, the incorporation of the hybridized graft copolymer imparts improved chemical properties, such as scratch resistance and chemical resistance. In some embodiments, the incorporation of the hybridized graft copolymer provides improved adhesion while also enabling removal upon exposure to typical recycle conditions. In some embodiments, the incorporation of the hybridized graft copolymer imparts improved interplay bonding between two dissimilar substrates. Without being bound to any particular theory, it is believed that the functional groups in the branches of the hybridized graft copolymer impart a repulsive energy between polymer chains. This generates an energy penalty of mixing when the material is dissolved in solution. This energy penalty increases as the concentration of the graft copolymer in the photopolymerizable liquid increases, eventually becoming larger than the energy penalty imparted by having the coating organize on a surface upon which it is deposited. This energy penalty from the interaction of the graft copolymer with itself causes the coating to spread out onto various surfaces in a manner different from traditional surfactants. This causes the coating to push into the substrate, improving adhesion even for systems that normally would have little to no adhesion alone and agnostic to the type of surface upon which it is deposited.

The following discussion includes various embodiments that do not limit the scope of the appended claims. Any examples set forth herein are intended to be non-limiting and merely illustrate some of the many possible embodiments of the disclosure. Further, particular features described herein can be used in combination with other described features in each of the various possible combinations and permutations. Unless otherwise specifically defined herein, all terms are to be given their broadest reasonable interpretation including meanings implied from the specification as well as meanings understood by those skilled in the art and/or as defined in dictionaries, treatises, etc. If the construction of a term would render it meaningless or essentially meaningless in its context, the term definition should be taken from a standard dictionary.

As used herein to define various components of the UV-curable compositions disclosed herein, unless otherwise indicated, the singular forms “a,” “an,” and “the” are intended to include one or more of the components (that is, including plurality referents).

The use of numerical values in the various ranges specified herein, unless otherwise expressly indicated otherwise, are considered to be approximations as though the minimum and maximum values within the stated ranges were both preceded by the word “about.” In this manner, slight variations above and below the stated ranges can be used to achieve substantially the same results as the values within the ranges. In addition, the disclosure of these ranges is intended as a continuous range including every value between the minimum and maximum values.

Unless otherwise indicated, the term “weight %” or “wt %” refers to the amount of a component or material based on the total solids of a composition, formulation, or layer. Unless otherwise indicated, the percentages can be the same for either a dry layer or pattern, or for the total solids of the formulation or composition.

As used herein, “(meth)acrylate” is inclusive of both acrylate and methacrylate functionality.

The term “homopolymer” is meant to refer to polymeric materials that have the same repeating or recurring unit along a polymer backbone. The term “copolymer” refers to polymeric materials composed of two or more different repeating or recurring units that are arranged in any order (randomly or otherwise) along the reactive polymer backbone.

For the reactive polymers used in the present invention, the recurring units can be arranged randomly along the reactive polymer backbone, or there can be blocks of recurring units that occur naturally during the polymerization process.

The term “polymerization” is used herein to mean the combining, for example by covalent bonding, of a large number of smaller molecules, such as monomers, to form very large molecules, that is, macromolecules or polymers. The monomers can be combined to form only linear macromolecules or they can be combined to form three-dimensional macromolecules that are commonly referred to as crosslinked or branched polymers. One type of polymerization that can be carried out in the practice of this invention is free radical polymerization when free radical reactive ethylenically unsaturated polymerizable monomers and suitable free radical generating initiators are present.

The term “functional” when referring to a polymeric portion of a molecule means that the polymer portion of the molecule has covalent bonds to other portions of the molecule.

The phrase “functionalized polymer” refers to a polymer that contains functional groups. Such functional groups are typically reactive towards other reactants, which may be useful in synthesis of further polymers. Examples of such functional groups includes hydroxide.

The term “liquid” in liquid UV curable inkjet ink means that inkjet ink is a liquid at room temperature (25° C.), thereby stating that the liquid UV curable inkjet ink is not a so-called UV curable phase change or hot melt inkjet ink.

The term “cure” or “curing” in the context of the present disclosure refers to a process of converting a liquid composition, such as a varnish or ink, into a solid by exposure to actinic radiation such as photo radiation, e.g., ultraviolet (UV) radiation. In the uncured state, the compositions have a low viscosity and can be readily jetted, for example. However, upon exposure to a suitable source of curing energy, for example ultraviolet (UV) light, electrons beam energy, and/or the like, there is a formation of a cross-linked polymer network. Such compositions are commonly referred to as “photo-curable” compositions.

The term “number average molecular weight” or “Mₙ” in reference to a particular component (e.g., a high molecular weight polymer binder) of a solid-state composition refers to the statistical average molecular weight of all molecules of the component expressed in units of g/mol. The number average molecular weight may be determined by techniques known in the art such as, for example, gel permeation chromatography (wherein Mₙ can be calculated based on known standards based on an online detection system such as a refractive index, ultraviolet, light scattering, viscosity, or other detector), viscometry, mass spectrometry, or colligative methods (e.g., vapor pressure osmometry, end-group determination, or proton NMR). The number average molecular weight is defined by the equation below,

Mₙ=ΣNᵢMᵢ/ΣNᵢ

wherein Mᵢ is the molecular weight of a molecule and Nᵢ is the number of molecules of that molecular weight. Unless specified otherwise, all molecular weights referred to herein are number average molecular weights.

The compositions disclosed herein may be deposited as a film or may be printed to form an image, which upon exposure to energy (visible, UV or electron beam radiation) polymerize to form a solid coating. The disclosed compositions can be used in laminating and pressure sensitive adhesive applications, coatings, inks and specialty release coatings. The disclosed compositions can be applied to many types of substrates, including but not limited to wood, paper, plastics, metal and glass and can be deposited using techniques such as spray coating, vacuum deposition, roll coating, curtain coating or gravure, screen, flexographic, offset or digital printing. The function of the disclosed compositions can be as a primer, basecoat, topcoat or tie-layer (coating layer between two substrates). Each of these application spaces and techniques requires specific formulation adjustments based on application method (i.e., viscosity) and desired properties of the finished film (reactivity, scratch resistance, abrasion resistance, adhesion, chemical resistance, physical drying, hardness and flexibility). Typically, selection of monomers and oligomers in a formulation is made to maximize desired properties but requires trade-offs depending on those desired properties and the viscosity requirements of the application method. In some embodiments, the disclosed composition provides the ability to achieve enhanced physical properties, such as adhesion, scratch resistance and chemical resistance.

In some embodiments, the compositions disclosed herein eliminate or minimize the use of oligomeric compounds, which have otherwise been necessary in the prior art to achieve desired physical properties of the liquid compositions or the cured composition but can increase the viscosity of formulations as they are incorporated at higher concentrations. As a result, the disclosed compositions allow for increased use of reactive diluents (monomers) that reduce the overall viscosity of the system, providing more formulation latitude.

The compositions disclosed herein are removable during recycling processes. In general, “recycling” refers to the collection process of materials or items post-consumer use and allowing those materials and/or items to be further processed in a cost-effective manner into identifiable new products. Thus, removal of coatings deposited on these materials or items is key to being able to return these materials to a usable form. Photopolymerizable coatings designed for high scratch resistance and adhesion are often difficult to remove because the trade-off between achieving those properties is that they do not break down in the recycle process. However, the compositions disclosed herein eliminate or minimize the use of oligomeric materials, enabling the removal of the deposited coatings under normal recycle conditions while still achieving desired adhesion and scratch resistance properties.

### Compositions

Disclosed herein are photopolymerizable liquid compositions comprising: at least one reactive diluent monomer; a hybridized graft copolymer dissolved in the at least one reactive diluent monomer, wherein the hybridized graft copolymer comprises: (a) a hydrophobic functional polymeric backbone, wherein the backbone comprises (i) an acrylate polymer, an alkylacrylate polymer, an olefin polymer, a functional vinyl polymer, a functional siloxane polymer or a mixture of these functionalities, wherein the backbone has an average molecular weight (Mₙ) of from about 3,000 to about 200,000 g/mol; and b) a plurality of hydrophilic polymeric side chains attached to the hydrophobic functional polymeric backbone, wherein the hydrophilic polymeric side chains comprise a polymerization product of at least one polymerizable unsaturated monomer and a polymerizable amine-containing unsaturated monomer; optionally, at least one colorant selected from the group consisting of a dye and a pigment; optionally, at least one oligomer; and optionally, at least one photoinitiator.

The compositions disclosed herein are free of added water.

### Reactive Diluent

Compositions disclosed herein comprise at least one reactive diluent monomer (also interchangeably referred to herein as the monomer or monomers) and can be any monomer that is suitable for formulations adhesives, coatings or inks. A “monomer” refers to organic compounds having a relatively low molecular weight (e.g., generally less than 2000 g/mol), and which may undergo chemical self-reaction (e.g., polymerization) or chemical reaction with other monomers (e.g., copolymerization) to form longer chain oligomers, polymers and copolymers. Monomers typically are unsaturated organic compounds, i.e., compounds having at least one carbon-carbon double bond. Preferably, the monomers disclosed herein are radiation curable.

The reactive diluent functions in part to reduce the viscosity of liquid compositions, improve flexibility, control cure speed, and adjust for desired application and film performance properties such as, for example, hardness, adhesion, chemical resistance or reduced shrinkage. Non-limiting examples of suitable monomer classes for use in the disclosed compositions include mono-, di- and multi-functional acrylates, methacrylates, styrenes, caproplactams, pyrrolidones, formamids, silanes and vinyl ethers. Non-limiting examples of suitable monomers for use in the disclosed compositions include isophoryl acrylate, isodecyl acrylate, tridecyl acrylate, lauryl acrylate, 2-(2-ethoxy-ethoxy)ethyl acrylate, tetrahydrofurfuryl acrylate, propoxylated acrylate, tetrahydrofurfuryl methacrylate, 2-phenoxyethyl methacrylate, isobornyl methacrylate, 3,3,5-trimethylcyclohexyl methacrylate, octyl decyl acrylate, tridecyl acrylate, isodecyl methacrylate, stearyl acrylate, stearyl methacrylate, 1,12 dodecane diol diacrylate, 1,3-butylene glycol diacrylate, 1,4-butanediol diacrylate, 1,6-hexanediol diacrylate, alkoxylated hexanediol diacrylate, alkoxylated neopentyl glycol diacrylate, cyclohexane dimethanol diacrylate, diethylene glycol diacrylate, phenoxyethyl acrylate (POEA), 4-t-butylcyclohexyll acrylate, butyl methacrylate (BMA), butanediol-mono-acrylate, trimethylolpropanformal acrylate, tripropyleneglycol diacrylate (TPGDA), dipropyleneglycol diacrylate (DPGDA), hexanediol diacrylate (HDDA), isobornyl acrylate (IBOA), neopentylgloycol diacrylate (NPGDA), trimethylolopropan triacrylate (TMPTA), tricyclodecane dimethanol diacrylate (TCCDA), and combinations thereof.

In embodiments, the reactive diluent is selected from the group consisting of an alkyl (meth)acrylate monomer and a polyfunctional (meth)acrylate monomer. The alkyl (meth)acrylate compound may be an alkyl (meth)acrylate whose alkyl group has 1 to 20 carbon atoms. Specific examples thereof include 2-(acetoacetoxy)ethyl methacrylate (AAEMA), methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, n-heptyl (meth)acrylate, n-octyl (meth)acrylate, isooctyl (meth)acrylate, 2-ethylhexyl (meth)acrylate, n-nonyl (meth)acrylate, isononyl (meth)acrylate, decyl (meth)acrylate, lauryl (meth)acrylate, stearyl (meth)acrylate, etc. These can be used singly as one species or in a combination of two or more species.

Polyfunctional (meth)acrylate monomers include difunctional and trifunctional (meth)acrylates. Suitable, illustrative difunctional (meth)acrylates include 1,12 dodecane diol diacrylate, 1,3-butylene glycol diacrylate, 1,4-butanediol diacrylate, 1,6-hexanediol diacrylate (e.g., SR238B from Sartomer Chemical Co.), alkoxylated hexanediol diacrylate, alkoxylated neopentyl glycol diacrylate, cyclohexane dimethanol diacrylate, diethylene glycol diacrylate (e.g., SR230 from Sartomer Chemical Co.), ethoxylated (4) bisphenol A diacrylate (e.g., SR601 from Sartomer Chemical Co.), neopentyl glycol diacrylate, polyethylene glycol (400) diacrylate (e.g., SR344 from Sartomer Chemical Co.), propoxylated (2) neopentyl glycol diacrylate (e.g., SR9003B from Sartomer Chemical Co.), tetraethylene glycol diacrylate (e.g., SR268 from Sartomer Chemical Co.), tricyclodecane dimethanol diacrylate (e.g., SR833S from Sartomer Chemical Co.), triethylene glycol diacrylate (e.g., SR272 from Sartomer Chemical Co.), and tripropylene glycol diacrylate.

Butyl methacrylate (BMA) and isobornyl acrylate (IBOA) are preferred reactive diluents.

The reactive diluent typically comprises the majority of the composition and can be added in an amount necessary to achieve the desired viscosity and/or end use properties. In some embodiments, the reactive diluent is present in an amount of from about 20 wt. % to about 90 wt. %, from about 30 wt. % to about 80 wt. %, from about 40 wt % to about 70 wt % and from about 50 wt. % to about 60 wt. %, based on the total weight of the composition (e.g., an uncured photopolymerizable formulation).

### Hybridized Graft Copolymer

The compositions disclosed herein comprise a hybridized graft copolymer dissolved in the at least one reactive diluent monomer, wherein the hybridized graft copolymer comprises: (a) a hydrophobic functional polymeric backbone, wherein the backbone comprises (i) an acrylate polymer, an alkylacrylate polymer, an olefin polymer, a functional vinyl polymer, a functional siloxane polymer or a mixture of these functionalities, wherein the backbone has an average molecular weight (Mₙ) of from about 3,000 to about 200,000 g/mol; and b) a plurality of hydrophilic polymeric side chains attached to the hydrophobic functional polymeric backbone, wherein the hydrophilic polymeric side chains comprise a polymerization product of at least one polymerizable unsaturated monomer and a polymerizable amine-containing unsaturated monomer. Preferred hybridized graft copolymers are disclosed in U.S. Pat. No. 9,441,123 and International Patent Application Serial No. PCT/US2020/025344 (filed Mar. 27, 2020), the disclosures of which are incorporated herein by reference in their entireties. Although the hybridized graft copolymers disclosed in U.S. Pat. No. 9,441,123 and International Patent Application Serial No. PCT/US2020/025344 are cationic and disclosed for use in aqueous systems, it has been surprisingly discovered that the hybridized graft copolymers can be produced in solid (i.e., powder) form and dissolved in the reactive diluent monomers to produce compositions that can adhere to many surfaces (substrates) that are otherwise difficult to adhere to, yield improved physical properties of the coatings, and ease of removal during recycling applications.

The hybridized graft copolymers disclosed herein are synthesized in a solvent such as, for example, methyl ethyl ketone (MEK) as disclosed in U.S. Pat. No. 9,441,123 and International Patent Application Serial No. PCT/US2020/025344 and then isolated as a powder by precipitation through addition of one-part polymer-containing MEK to 10 parts water. The water/MEK mixture is then removed from the resulting slurry through filtration and further dried using a fluidized bed at 30° C. with an air flow rate of, for example, 10-100 cfm. The resulting solid copolymer is a yellow-white powder ranging in molecular weight (Mₙ) from 6,000-150,000 g/mol with low levels of residual MEK (0-1000 ppm) that is surprisingly soluble in multiple photopolymerizable monomers.

In some embodiments, the hybridized graft copolymers disclosed herein comprise: a hydrophobic functional polymeric backbone of an average molecular weight of from about 3,000 to about 200,000 g/mol, wherein the polymeric backbone comprises a polymer selected from the group consisting of a functional vinyl polymer, a functional siloxane polymer, a functional olefin polymer, an acrylate polymer, an alkylacrylate polymer, or both an acrylate polymer and an alkylacrylate polymer; and a plurality of copolymeric side chains attached to the backbone, wherein one or more side chains comprises a reaction product of at least a polymerizable unsaturated monomer and a polymerizable amine-containing unsaturated monomer.

A graft copolymer is a branched copolymer wherein the side chains are structurally distinct from the backbone. In the present invention the backbone of the graft copolymer is the hydrophobic functional polymeric backbone, and the side chains are copolymeric side chains attached to the backbone.

The hybridized graft copolymers disclosed herein comprise at least a backbone and a plurality of copolymeric side chains. The backbone is a hydrophobic functional polymeric chain.

In some embodiments, the hydrophobic functional polymeric backbone may be synthesized from base monomers. In some embodiments, the hydrophobic functional polymeric backbone may be purchased, such as a functional vinyl chloride-vinyl acetate-vinyl alcohol terpolymer (UMOH Vinyl Terpolymer Resin, Wuxi Honghui New Materials Technology Co., Ltd).

The polymeric chain that comprises the backbone can be either a functional homopolymer or a functional copolymer. The backbone comprises i) a functional polyolefin polymer, a functional siloxane polymer, a functional polyvinyl polymer, or any copolymer of the two; and ii) an acrylate polymer, an alkylacrylate polymer, or both an acrylate polymer and an alkylacrylate polymer. In a preferred embodiment the backbone is a functional copolymer.

In some embodiments, the functional polyolefin polymer is a polyolefin polymer that has covalent bonds to other parts of the molecule, namely to copolymeric side chains. Polyolefin polymer is a polymer produced from one or more alkene monomers with a general formula CₙH₂ₙ, wherein n is 2 to 8. Such alkenes may be linear or branched. Examples of alkenes include ethylene, propylene, butylene, pentene, hexene and octene. Examples of suitable polyolefins include functional polyethylene, functional polypropylene, functional polybutene, functional polyisobutylene, functional polymethylpentene, and copolymers thereof.

In some embodiments, the functional polyvinyl polymer is a polyvinyl polymer that has covalent bonds to other parts of the molecule, namely copolymeric side chains. Polyvinyl polymer is a polymer produced from one or more vinyl monomers. Examples of vinyl monomers include vinyl chloride, vinyl acetate, and vinyl alcohol. Examples of suitable polyvinyl polymers include polyvinyl chloride, polyvinyl acetate, polyvinyl alcohol, and copolymers thereof. Particularly suitable polyvinyl polymers that are copolymers of polyvinyl chloride, polyvinyl acetate and polyvinyl alcohol. One of the preferred polyvinyl vinyl polymers comprises copolymers based on about 60% to 95% vinyl chloride, 2% to 10% vinyl acetate, and 2% to 10% vinyl alcohol.

In some embodiments, the functional polysiloxane polymer is a polysiloxane polymer that has covalent bonds to other parts of the molecule, namely copolymeric side chains. Polysiloxane polymer is a linear polymer of formula [RR′SiO]ₙ, wherein R and R′ are the same or different organic groups such as hydrogen, alkyl, aryl, alkylaryl. Such alkyl groups may be linear or branched. Examples of suitable functional polysiloxane polymer include functional polydimethylsiloxane, functional polymethylhydrosiloxane, functional poly(methylhydro-co-dimethyl)siloxane, functional polyethylhydrosiloxane, functional polyphenyl-(dimethylhydro)siloxane, functional methylhydrosiloxane-phenylmethylsiloxane copolymer, functional methylhydrosiloxane-octylmethylsiloxane copolymer, and co-polymers of any two or more thereof.

In some embodiments, the functional acrylate polymer is an acrylate or alkylacrylate polymer that has covalent bonds to other parts of the molecule, namely copolymeric side chains. Examples of suitable functional acrylates or alkylacrylates include functional polybutyl acrylate, a functional polyethyl hexyl acrylate, a functional polyethyl acrylate, a functional polymethyl methacrylate, and combinations of two or more thereof.

The molecular weight of the polymeric backbone portion of the copolymer is chosen to be such that the molecule that is the synthetic precursor to the copolymer is soluble in the reactive diluent. The preferred average number molecular weight (Mₙ) is from about 3,000 to about 200,000 g/mol.

In one embodiment, the backbone of the hybridized graft copolymer comprises (i) a functional vinyl chloride-containing polymer portion having an average molecular weight (Mₙ) of from about 15,000 to about 50,000 g/mol.

In one embodiment, as disclosed in PCT/US2020/025344, the hydrophobic backbones of the polymers disclosed herein can be prepared by polymerizing unsaturated monomers comprising an acrylate monomer, an alkylacrylate acrylate monomer (e.g., methacrylate monomer), or a combination of acrylate monomers and alkylacrylates.

In one embodiment, the hydrophobic backbone comprises a co-polymer of polybutylacrylate and poly(2-hydroxyethyl acrylate) as is detailed in Example 2 below.

The molecular weight of the polymeric backbone portion of the copolymer is chosen to be such that the molecule that is the synthetic precursor to the copolymer is soluble in organic solvents used in the reaction, and the resulting copolymer is soluble in the reactive diluent. The preferred number average molecular weight (Mₙ) of the backbone is from about 3,000 to about 200,000 g/mol, more preferably, from about 15,000 to about 50,000 g/mol, and in other embodiments from about 15,000 to about 30,000 g/mol.

To react with hydrophilic side chains, the polymer backbone preferably should contain vinyl, olefin, siloxane, acrylate or alkyl acrylate-containing functional groups of hydroxyl, primary amine, and secondary amine character. Therefore, the preferred backbone could be determined depending on % ratio of the vinyl, olefin, siloxane, acrylate or alkyl acrylate containing hydroxyl and primary and secondary amine groups in polymer backbone. Accordingly, a preferred backbone may contain the molar ratio (%) of the vinyl, olefin, siloxane, acrylate or alkyl acrylate containing hydroxyl and primary and secondary amine groups between about 5 and about 40 mol % and the non-functional vinyl, olefin, siloxane, acrylate or alkyl acrylate between about 95 and about 60%.

The weight ratio of the polymeric backbone in the hybridized copolymer of the present invention to the plurality of copolymeric side chains is selected so that the hybridized copolymer of the present disclosure provides for excellent adhesion of the disclosed photopolymerizable liquid after cure. The preferred weight ratio of the polymeric backbone in the hybridized copolymer of the present disclosure to the plurality of copolymeric side chains is between from about 5 wt % to about 95 wt %, from about 10 wt % to 90 wt %, from about 20 wt % to about 80 wt %, from about 30 wt % to about 70 wt %, from about 40 wt % to about 60 wt %.

In addition to a hydrophobic functional polymeric backbone, the hybridized copolymer of the present disclosure also comprises a plurality of copolymeric side chains attached to the backbone, wherein one or more side chains comprises a reaction product of at least (i) a polymerizable unsaturated monomer and (ii) a polymerizable amine-containing unsaturated monomer. Both polymerizable unsaturated and polymerizable amine-containing unsaturated monomers are needed in construction of a plurality of side chains, but additional material may be incorporated within any of the side chains.

In some embodiments, the plurality of the hydrophilic polymeric side chains are linked directly to the hydrophobic functional polymeric backbone through an alcoholysis reaction of isocyante-end capping side chain polymers by hydroxy-containing polymeric backbones using a Tin catalyst as disclosed in PCT/US2020/025344.

The polymerizable unsaturated monomer which is the basis for one type of a building unit of the side chains is selected from a group consisting of an acrylate monomer, an alkacrylate monomer, an aromatic vinyl monomer, an aliphatic vinyl monomer, a vinyl ester monomer, a vinyl cyanogen-containing monomer, a halogenoid monomer, an olefin monomer, and a diene monomer. Although only one kind of a polymerizable unsaturated monomer may be used in preparation of any of the side chains, typically several kinds of polymerizable unsaturated monomers are used.

In a broad form, the polymerizable unsaturated monomer, which is the basis of one type of repeating units within the side chain of the graft copolymer, has the structure represented by the formula:

CH₂═C(R²)—X—Y—R¹

wherein

—R² is H, halogen, or C₁ to C₃ alkyl group;

—X— is a bond, —CO—O—, or —O—CO—;

—Y— is a bond, or a C₁ to C₂₂ bridging alkyl group optionally substituted with one or more C₁ to C₆ alkyl groups; and

—R¹ is

(1) H, halide, —OH, or —CN;
(2) a C₃ to C₈ cycloalkyl group that is optionally substituted with one or more linear or branched C₁ to C₆ alkyl group;
(3) a C₃ to C₈ heterocycloalkyl group comprising one or more heteroatoms, wherein the heteroatom is a chalcogen;
(4) a C₇ to C₁₅ bicycloalkyl group that is optionally substituted with one or more halogens, or linear or branched C₁ to C₆ alkanes;
(5) a C₆ to C₁₄ aryl group that is optionally substituted with one or more groups selected from the group consisting of a halogen, a linear or branched C₁ to C₆ alkane, and C₁ to C₃ alkyloxy; (6) SiR³₃, wherein R³ is C₁ to C₃ alkyl group;
(7) polyethylene glycol, polypropylene glycol, or a copolymer thereof, terminated with —OH or —OMe;
(8) —CZ=CH₂, wherein Z is H or halogen; and

### (9) —CO—OH.

In cases when —X— is a bond, the formula CH₂=C(R²)—X—Y—R¹, is reduced to formula CH₂=C(R²)—Y—R¹. Likewise, when —Y— is a bond, the formula CH₂=C(R²)—X—Y—R¹, is reduced to formula CH₂=C(R²)—Y—R¹. Furthermore, when both —X— and —Y— are bonds, the formula CH₂=C(R²)—X—Y—R¹, is reduced to CH₂=C(R²)—R¹.

The symbol —CN refers to a cyanyl group. The cyanyl group should be chemically inert vis-à-vis conditions in which the copolymer may be exposed in order to avoid hydrolysis of the cyanyl group.

In another embodiment, the polymerizable unsaturated monomer which is the basis for the side chains is an acrylate monomer, an alkyl acrylate monomer, or both. The acrylate monomer also has a structure represented by the formula:

CH₂=C(R²)—X—Y—R¹

wherein

—R² is H;

—X— is —CO—O—;

—Y— is a bond, or a C₁ to C₂₂ bridging alkyl group optionally substituted with one or more C₁ to C₆ alkyl groups; and

—R¹ is

### (1) H or —OH;

(2) a C₃ to C₈ cycloalkyl group that is optionally substituted with one or more linear or branched C₁ to C₆ alkyl group;
(3) a C₃ to C₈ heterocycloalkyl group comprising one or more heteroatoms, wherein the heteroatom is a chalcogen;
(4) a C₇ to C₁₅ bicycloalkyl group that is optionally substituted with one or more halogens, or linear or branched C₁ to C₆ alkanes;
(5) a C₆ to C₁₄ aryl group that is optionally substituted with one or more groups selected from the group consisting of a halogen, a linear or branched C₁ to C₆ alkane, and C₁ to C₃ alkyloxy; or (6) polyethylene glycol, polypropylene glycol, or a copolymer thereof, terminated with —OH or —OMe.

The acrylate monomer also has a structure represented by the formula, CH₂=CH—CO—O—Y—R¹, wherein

—Y— is a bond, or a C₁ to C₂₂ bridging alkyl group optionally substituted with one or more C₁ to C₆ alkyl groups; and

—R¹ is

### (1) H or —OH;

(2) a C₃ to C₈ cycloalkyl group that is optionally substituted with one or more linear or branched C₁ to C₆ alkyl group;
(3) a C₃ to C₈ heterocycloalkyl group comprising one or more heteroatoms, wherein the heteroatom is a chalcogen;
(4) a C₇ to C₁₅ bicycloalkyl group that is optionally substituted with one or more halogens, or linear or branched C₁ to C₆ alkanes;
(5) a C₆ to C₁₄ aryl group that is optionally substituted with one or more groups selected from the group consisting of a halogen, a linear or branched C₁ to C₆ alkane, and C₁ to C₃ alkyloxy; or
(6) polyethylene glycol, polypropylene glycol, or a copolymer thereof, terminated with —OH or —OMe.

Examples of suitable acrylates include 2-hydroxyethyl acrylate, HEA, ethyl acrylate, methyl acrylate, n-propyl acrylate, i-propyl acrylate, n-butyl acrylate, i-butyl acrylate, t-butyl acrylate, n-pentyl acrylate, n-amyl acrylate, i-pentyl acrylate, isoamyl acrylate, n-hexyl acrylate, cyclohexyl acrylate, 2-ethylhexyl acrylate, octyl acrylate, i-octyl acrylate, decyl acrylate, isodecyl acrylate, dodecyl acrylate, lauryl acrylate, octadecyl acrylate, isobornyl acrylate, phenyl acrylate, benzyl acrylate, ethylene glycol methyl ether acrylate, glycidyl acrylate, and mixtures thereof. In one embodiment of the invention the acrylate monomers that are the basis of the copolymeric side chain is 2-hydroxylethyl acrylate, ethyl acrylate, or a mixture thereof.

The alkyl acrylate monomer includes monomers represented by the formula CH₂=C(R²)—X—Y—R¹, wherein

—R² is C₁ to C₃ alkyl;

—X— is —CO—O—;

—Y— is a bond, or a C₁ to C₂₂ bridging alkyl group optionally substituted with one or more C₁ to C₆ alkyl groups; and

—R¹ is

### (1) H;

(2) a C₃ to C₈ cycloalkyl group that is optionally substituted with one or more linear or branched C₁ to C₆ alkyl group;
(3) a C₃ to C₈ heterocycloalkyl group comprising one or more heteroatoms, wherein the heteroatom is a chalcogen;
(4) a C₇ to C₁₅ bicycloalkyl group that is optionally substituted with one or more halogens, or linear or branched C₁ to C₆ alkanes;
(5) a C₆ to C₁₄ aryl group that is optionally substituted with one or more groups selected from the group consisting of a halogen, a linear or branched C₁ to C₆ alkane, and C₁ to C₃ alkyloxy;
(6) SiR³₃, wherein R³ is C₁ to C₃ alkyl group;
(7) polyethylene glycol, polypropylene glycol, or a copolymer thereof, terminated with OH or OMe; or
(8) —CZ=CH₂, wherein Z is H or halogen.

An example of an alkylacrylate monomer according to the formula, CH₂=C(R²)—X—Y—R¹, is a methacrylate, wherein

—R² is C₁ alkyl;

—X— is —CO—O—;

—Y— is a bond, or a C₁ to C₂₂ bridging alkyl group optionally substituted with one or more C₁ to C₆ alkyl groups; and

—R¹ is

### (1) H;

(2) a C₃ to C₈ cycloalkyl group that is optionally substituted with one or more linear or branched C₁ to C₆ alkyl group;
(3) a C₃ to C₈ heterocycloalkyl group comprising one or more heteroatoms, wherein the heteroatom is a chalcogen;
(4) a C₇ to C₁₅ bicycloalkyl group that is optionally substituted with one or more halogens, or linear or branched C₁ to C₆ alkanes;
(5) a C₆ to C₁₄ aryl group that is optionally substituted with one or more groups selected from the group consisting of a halogen, a linear or branched C₁ to C₆ alkane, and C₁ to C₃ alkyloxy;
(6) SiR³₃, wherein R³ is C₁ to C₃ alkyl group;
(7) polyethylene glycol, polypropylene glycol, or a copolymer thereof, terminated with OH or OMe; or
(8) —CZ=CH₂, wherein Z is H or halogen.

Examples of suitable methacrylates include methyl methyacrylate, MMA, ethyl methacrylate, propyl methacrylate, isopropyl methacrylate, n-butyl methacrylate, i-butyl methacrylate, s-butyl methacrylate, t-butyl methacrylate, n-amyl methacrylate, isoamyl methacrylate, n-hexyl methacrylate, cyclohexyl methacrylate, 2-ethylhexyl methacrylate, octyl methacrylate, decyl methacrylate, dodecyl methacrylate, octadecyl methacrylate, behenyl methacrylate, lauryl methacrylate, isobornyl methacrylate (IBOMA), phenyl methacrylate, benzyl methacrylate, 1-naphthyl methacrylate, (trimethylsilyl)methacrylate, 9-anthracenylmethyl methacrylate, glycidyl methacrylate, polyethylene glycol monomethacrylate, polypropylene glycol monomethacrylate, ethylene glycol propylene glycol monomethacrylate, and mixtures thereof. In one embodiment of the invention the methacrylate monomers that are the basis of the copolymeric side chain is methyl 2-methacrylate, behenyl methacrylate, or a mixture thereof.

The aromatic vinyl monomer(s) is represented by the formula CH₂=C(R²)—R¹, wherein

—R² is H or C₁ to C₃ alkyl group;

—R¹ is a C₆ to C₁₄ aryl group that is optionally substituted with one or more groups selected from the group consisting of a halogen, a linear or branched C₁ to C₆ alkane, and C₁ to C₃ alkyloxy.

Aryl groups are any hydrocarbon cyclic groups that follow the Huckel Rule. Such aryl groups may be single aromatic ring group, bicyclic aromatic ring group, or tricyclic aromatic ring group. An example of a single aromatic ring group is the phenyl group. An example of a bicyclic aromatic ring group is naphthalene. An example of a tricyclic aromatic ring group is anthracene. Any of the aromatic groups may be optionally substituted with one or more of any of the following: fluorine, chlorine, bromine, iodine, methyl, ethyl, propyl, butyl, pentyl, hexyl, methoxy, ethoxy, propyloxy, including any isomers thereof.

Examples of suitable aromatic vinyl monomer include styrene, alpha-methylstyrene, vinyl toluene, 4-t-butylstyrene, chlorostyrene, vinylanisole, vinyl naphthalene, and mixtures thereof.

The vinyl ester monomer(s) is represented by the formula

CH₂=CH—O—CO—Y—R¹,

wherein

—Y— is a bond, or a C₁ to C₂₂ bridging alkyl group optionally substituted with one or more C₁ to C₆ alkyl groups; and

—R¹ is

(1) H, halide, —OH, or —CN;
(2) a C₃ to C₈ cycloalkyl group that is optionally substituted with one or more linear or branched C₁ to C₆ alkyl group;
(3) a C₃ to C₈ heterocycloalkyl group comprising one or more heteroatoms, wherein the heteroatom is a chalcogen;
(4) a C₇ to C₁₅ bicycloalkyl group that is optionally substituted with one or more halogens, or linear or branched C₁ to C₆ alkanes;
(5) a C₆ to C₁₄ aryl group that is optionally substituted with one or more groups selected from the group consisting of a halogen, a linear or branched C₁ to C₆ alkane, and C₁ to C₃ alkyloxy;
(6) SiR³₃, wherein R³ is C₁ to C₃ alkyl group;
(7) polyethylene glycol, polypropylene glycol, or a copolymer thereof, terminated with —OH or —OMe; or
(8) —CZ=CH₂, wherein Z is H or halogen.

An example of a suitable vinyl ester is vinyl acetate.

The vinyl cyanogen-containing monomer is an unsaturated monomer that comprises a —CN group. Examples of cyanogen-containing monomer include acrylonitrile and methacrylonitrile.

The halogenoid monomer is an unsaturated monomer that comprises one or more halogens. An example of a halogen includes fluorine, chlorine, bromine and iodine. An example of a halogenoid comprising one halogen is vinyl chloride. An example of a halogenoid comprising two halogens is vinylidene chloride.

The olefin monomer(s) has a structure represented by the formula

CH₂=C(R²)—Y—R¹,

wherein

—R² is H, or C₁ to C₃ alkyl group;

—Y— is a bond, or a C₁ to C₂₂ bridging alkyl group optionally substituted with one or more C₁ to C₆ alkyl groups; and

—R¹ is H.

Examples of an olefin monomer include ethylene, propylene, and mixtures thereof.

The diene monomer(s) is represented by the formula

CH₂=CH—Y—R¹,

wherein

—Y— is a bond, or a C₁ to C₂₂ bridging alkyl group optionally substituted with one or more C₁ to C₆ alkyl groups; and

—R¹ is —CZ=CH₂, wherein Z is H or halogen.

An example of a diene monomer when Z=H is butadiene. An example of a diene monomer when Z is a halogen is chloroprene.

The polymerizable amine-containing unsaturated monomer which is the basis for one type of a building unit of the side chains is selected from the group consisting of an amine-containing acrylate, an amine-containing methacrylate, an acrylamide, a methacrylamide, an amine-containing vinyl monomer, and mixtures thereof.

The polymerizable amine-containing unsaturated monomer which is the basis of one type of repeating units within the side chain of graft copolymer has a structure represented by the formula:

CH₂=C(Rⁿ²)—Xⁿ—Yⁿ—Rⁿ¹

wherein

—R² is H, halogen, or C₁ to C₃ alkyl group;

—Xⁿ— is a bond, —CO—O—, —CO—NH—, —CO—, —O—, or —S—;

—Yⁿ— is a bond, or a C₁ to Cis bridging alkyl group optionally substituted with one or more C₁ to C₆ alkyl groups; and

—Rⁿ¹ is

### (1) H;

(2) NRⁿ³Rⁿ⁴, wherein Rⁿ³ and Rⁿ⁴ are each independently selected from the group consisting of H, a C₁ to C₁₂ linear or branched alkyl group, a C₁ to C₁₂ linear or branched alkylene group, a C₃ to C₈ cycloalkyl group, and C₁ to C₁₂ linear or branched alkyl group substituted with one or more hydroxyl groups;
(3) a C₃ to C₈ heterocycloalkyl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₁₂ alkane, halogen, C₁ to C₃ alkoxy group, and an oxo group;
(4) a C₆ to C₁₄ heteroaryl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₆ alkane, halogen, C₁ to C₃ alkyl ether, and an oxo group;
(5) a C₆ to C₁₄ aryl group further substituted with an amine-containing group;
(6) a C₁ to C₈ alkyl group substituted with a plurality of aryl groups; or
(7) polyethylene glycol, polypropylene glycol, or a copolymer thereof, terminated with —OH or —OMe; and wherein —Xⁿ— or —Rⁿ¹ or both comprise nitrogen.

In cases when —Xⁿ— is a bond, the formula CH₂=C(R²)—Xⁿ—Yⁿ—Rⁿ¹, is reduced to formula CH₂=C(Rⁿ²)—Yⁿ—Rⁿ¹. Likewise, when —Yⁿ— is a bond, the formula CH₂=C(R²)—Xⁿ—Yⁿ—Rⁿ¹, is reduced to formula CH₂=C(R²)—Yⁿ—Rⁿ¹. Furthermore, when both —Xⁿ— and —Yⁿ— are bonds, the formula CH₂=C(Rⁿ²)—Xⁿ—Yⁿ—Rⁿ¹, is reduced to CH₂=C(R²)—Rⁿ¹.

The definition of amine containing unsaturated monomer also includes adducts of such monomers, such as salts, quaternary amine salts, and hydrates.

In one embodiment of the present disclosure, the polymerizable amine-containing unsaturated monomer which is the basis for the side chains is an amine-containing acrylate monomer. The amine-containing acrylate monomer(s) has a structure represented by the formula

CH₂=CH—CO—O—Yⁿ—Rⁿ¹

wherein

—Yⁿ— is a bond, or a C₁ to Cis bridging alkyl group optionally substituted with one or more C₁ to C₆ alkyl groups; and

—Rⁿ¹ is

(1) NRⁿ³Rⁿ⁴, wherein Rⁿ³ and Rⁿ⁴ are each independently selected from the group consisting of H, a C₁ to C₁₂ linear or branched alkyl group, a C₁ to C₁₂ linear or branched alkylene group, a C₃ to C₈ cycloalkyl group, and C₁ to C₁₂ linear or branched alkyl group substituted with one or more hydroxyl groups;
(2) a C₃ to C₈ heterocycloalkyl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₁₂ alkane, halogen, C₁ to C₃ alkoxy group, and an oxo group;
(3) a C₆ to C₁₄ heteroaryl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₆ alkane, halogen, C₁ to C₃ alkyl ether, and an oxo group; or
(4) a C₆ to C₁₄ aryl group further substituted with an amine-containing group.

When the polymerizable amine-containing unsaturated monomer which is the basis for the side chains is an amine-containing acrylate monomer of formula CH₂=CH—CO—O—Yⁿ—Rⁿ¹, then moiety —Rⁿ¹ comprises nitrogen.

Examples of suitable polymerizable amine-containing acrylate include t-butylaminoethyl acrylate, dimethylaminomethyl acrylate, diethylaminoethyl acrylate, oxazolidinyl ethyl acrylate, aminoethyl acrylate, 4-(beta-acryloxyethyl)-pyridine, 2-(4-pyridyl)-ethyl acrylate, and mixtures thereof.

In another embodiment, the polymerizable amine-containing unsaturated monomer which is the basis for the side chains is an amine-containing methacrylate monomer. The amine-containing methacrylate monomer has a structure represented by the formula

CH₂=C(CH₃)—CO—O—Yⁿ—Rⁿ¹,

wherein

—Yⁿ— is a bond, or a C₁ to Cis bridging alkyl group optionally substituted with one or more C₁ to C₆ alkyl groups; and

—Rⁿ¹ is

(1) NRⁿ³Rⁿ⁴, wherein Rⁿ¹ and Rⁿ⁴ are each independently selected from the group consisting of H, a C₁ to C₁₂ linear or branched alkyl group, a C₁ to C₁₂ linear or branched alkylene group, a C₃ to C₈ cycloalkyl group, and C₁ to C₁₂ linear or branched alkyl group substituted with one or more hydroxyl groups;
(2) a C₃ to C₈ heterocycloalkyl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₁₂ alkane, halogen, C₁ to C₃ alkoxy group, and an oxo group;
(3) a C₆ to C₁₄ heteroaryl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₆ alkane, halogen, C₁ to C₃ alkyl ether, and an oxo group; or
(4) a C₆ to C₁₄ aryl group further substituted with an amine-containing group.

When the polymerizable amine-containing unsaturated monomer which is the basis for the side chains is an amine-containing acrylate monomer of formula CH₂=C(CH₃)—CO—O—Yⁿ—Rⁿ¹, then moiety —Rⁿ¹ comprises nitrogen.

Examples of suitable polymerizable amine-containing methacrylate include 2-aminoethyl methacrylate, t-butylaminoethyl methacrylate, 2-(diethylamino)ethyl methacrylate, dimethylaminomethyl methacrylate, diethylaminoethyl methacrylate, 2-dimethylaminoethyl methacrylate, DMAEMA, oxazolidinyl ethylmethacrylate, aminoethyl methacrylate, diethylaminohexyl methacrylate, 3-dimethylamino-2,2-dimethyl-propyl methacrylate, methacrylate of N-hydroxyethyl-2,4,4-trimethylpyrrolidine, 1-dimethylamino-2-propyl methacrylate, beta-morpholinoethyl methacrylate, 3-(4-pyridyl)-propyl methacrylate, 1-(4-pyridyl)-ethyl methacrylate, 1-(2-methacryloyloxyethyl)-2-imidazolidinone, Norsocryl 102, 3-(beta-methacryloxyethyl)-pyridine, 3-methacryloxypyridine, oxazolidinyl ethyl methacrylate, and mixtures thereof.

In one embodiment of the present invention the amine-containing methacrylate is selected from the group consisting of t-butylaminoethyl methacrylate, 2-dimethylaminoethyl methacrylate, DMAEMA, and 1-(2-methacryloyloxyethyl)-2-imidazolidinone.

The acrylamide has a structure represented by the formula

CH₂=CH—Xⁿ—Yⁿ—Rⁿ¹,

wherein

—Xⁿ— is —CO—NH—, or —CO—;

—Yⁿ— is a bond, or a C₁ to Cis bridging alkyl group optionally substituted with one or more C₁ to C₆ alkyl groups; and

—Rⁿ¹ is

### (1) H;

(2) NRⁿ³Rⁿ⁴, wherein Rⁿ³ and Rⁿ⁴ are each independently selected from the group consisting of H, a C₁ to C₁₂ linear or branched alkyl group, a C₁ to C₁₂ linear or branched alkylene group, a C₃ to C₈ cycloalkyl group, and C₁ to C₁₂ linear or branched alkyl group substituted with one or more hydroxyl groups;
(3) a C₃ to C₈ heterocycloalkyl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₁₂ alkane, halogen, C₁ to C₃ alkoxy group, and an oxo group;
(4) a C₆ to C₁₄ heteroaryl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₆ alkane, halogen, C₁ to C₃ alkyl ether, and an oxo group;
(5) a C₆ to C₁₄ aryl group further substituted with an amine-containing group;
(6) a C₁ to C₈ alkyl group substituted with a plurality of aryl groups; or
(7) polyethylene glycol, polypropylene glycol, or a copolymer thereof, terminated with —OH or —OMe; and

provided that when —Xⁿ— is —CO—, then —X— is a bond and —Rⁿ¹ is NRⁿ³Rⁿ⁴, wherein Rⁿ³ and Rⁿ⁴ are each independently selected from the group consisting of H, a C₁ to C₁₂ linear or branched alkyl group, a C₁ to C₁₂ linear or branched alkylene group, a C₃ to C₈ cycloalkyl group, and C₁ to C₁₂ linear or branched alkyl group substituted with one or more hydroxyl groups.

Acrylamide that is a suitable polymerizable amine-containing unsaturated monomer which is the basis for the side chain of the copolymer of the present invention has a nitrogen as a part of the acrylamide group CH₂=CH—CO—NH— or CH₂=CH—CO—NRⁿ³Rⁿ⁴. Further, in addition to the nitrogen, which is a part of the acrylamide group, acrylamide that is a suitable polymerizable amine-containing unsaturated monomer may have one or more additional nitrogen atoms on the Rⁿ¹ group, making each repeating unit have at least two nitrogen atoms.

Examples of suitable acrylamides include N,N-dimethylacrylamide, NNDMA, N-acryloylamido-ethoxyethanol, N-t-butylacrylamide, N-diphenylmethyl acrylamide, and N-(beta-dimethylamino)ethyl acrylamide. Of these acrylkamides, N,N-dimethylacrylamide, NNDMA, and N-(beta-dimethylamino)ethyl acrylamide have two nitrogen atoms.

In another embodiment the acrylamide is N,N-dimethylacrylamide, or NNDMA.

A methacrylamide has a structure represented by the formula

CH₂=C(CH₃)—Xⁿ—Yⁿ—Rⁿ¹

wherein

—Xⁿ— is —CO—NH—, or —CO—;

—Yⁿ— is a bond, or a C₁ to Cis bridging alkyl group optionally substituted with one or more C₁ to C₆ alkyl groups; and

—Rⁿ¹ is

### (1) H;

(2) NRⁿ³Rⁿ⁴, wherein Rⁿ¹ and Rⁿ⁴ are each independently selected from the group consisting of H, a C₁ to C₁₂ linear or branched alkyl group, a C₁ to C₁₂ linear or branched alkylene group, a C₃ to C₈ cycloalkyl group, and C₁ to C₁₂ linear or branched alkyl group substituted with one or more hydroxyl groups;
(3) a C₃ to C₈ heterocycloalkyl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₁₂ alkane, halogen, C₁ to C₃ alkoxy group, and an oxo group;
(4) a C₆ to C₁₄ heteroaryl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₆ alkane, halogen, C₁ to C₃ alkyl ether, and an oxo group;
(5) a C₆ to C₁₄ aryl group further substituted with an amine-containing group;
(6) a C₁ to C₈ alkyl group substituted with a plurality of aryl groups; or
(7) polyethylene glycol, polypropylene glycol, or a copolymer thereof, terminated with —OH or —OMe; and

provided that when —Xⁿ— is —CO—, then —X— is a bond and —Rⁿ¹ is (2).

Methacrylamide that is a suitable polymerizable amine-containing unsaturated monomer which is the basis for the side chain of the copolymer of the present invention has a nitrogen as a part of the methacrylamide group CH₂=C(CH₃)—CO—NH— or CH₂=C(CH₃)—CO—NRⁿ³Rⁿ⁴. Further, in addition to the nitrogen, which is a part of the acrylamide group, acrylamide that is a suitable polymerizable amine-containing unsaturated monomer may have one or more additional nitrogen atoms on the Rⁿ¹ group, making each repeating unit have at least two nitrogen atoms.

Examples of suitable methacrylamides include N-(3-dimethylaminopropyl) methacrylamide and N-(beta-dimethylamino)ethyl methacrylamide. Both of these exemplary compounds contain two nitrogen atoms.

An amine-containing vinyl monomer has a structure represented by the formula

CH₂=CH—Xⁿ—Yⁿ—Rⁿ¹,

wherein

—Xⁿ— is a bond, —O—, or —S—;

—Yⁿ— is a bond, or a C₁ to C₁₈ bridging alkyl group optionally substituted with one or more C₁ to C₆ alkyl groups; and

—Rⁿ¹ is

(1) NRⁿ³Rⁿ⁴, wherein Rⁿ¹ and Rⁿ⁴ are each independently selected from the group consisting of H, a C₁ to C₁₂ linear or branched alkyl group, a C₁ to C₁₂ linear or branched alkylene group, a C₃ to C₈ cycloalkyl group, and C₁ to C₁₂ linear or branched alkyl group substituted with one or more hydroxyl groups;
(2) a C₃ to C₈ heterocycloalkyl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₁₂ alkane, halogen, C₁ to C₃ alkoxy group, and an oxo group;
(3) a C₆ to C₁₄ heteroaryl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₆ alkane, halogen, C₁ to C₃ alkyl ether, and an oxo group; and
(4) a C₆ to C₁₄ aryl group further substituted with an amine-containing group.

The copolymeric side chains that are attached to the hydrophobic functional polymeric backbone may optionally comprise additional components. Such components may be added within the structure of side chains and may be used to improve the physical or chemical properties of the graft copolymer, such as the stability of the ink. One such component is a structural unit that acts as a UV absorber. Such a UV absorber will dissipate the energy that is absorbed by the printed ink thus mitigating the aging process of the printed ink. Such a UV absorber will absorb the UV radiation and prevent the formation of free radicals. Examples of UV absorbers that may be incorporated into the side chains include benzophenones, hindered amine light stabilizers, benzotriazoles, nickel quenchers, 2-(2′-hydroxy-5′-methacryloyloxy ethylphenyl)-2-H-benzotriazole, Ruva 93, bis(1,2,2,6,6-pentamethyl-4-piperidinyl)sebacate and methyl(1,2,2,6,6-pentamethyl-4-piperidinyl)sebacate, and bis(2,2,6,6-tetramethyl-4-piperidyl) sebacate.

The hybridized graft copolymer component of the compositions disclosed herein is typically present in an amount of from about 0.5 wt. % to about 16 wt. % in some embodiments (based on the total weight of the composition), from about 1.0 wt. % to about 13 wt. % in some embodiments, from about 3.0 wt. % to about 11 wt. % in some embodiments, from about 5.0 wt. % to about 11 wt. % in some embodiments, and from about 7 wt. % to about 9 wt. % in other embodiments. In some embodiments, the hybridized graft copolymer powder is added to the disclosed photopolymerizable liquid formulation to enhance adhesion. In some embodiments, the hybridized graft copolymer powder is added to the disclosed photopolymerizable liquid as a full or partial replacement for the oligomer in the formulation. In some embodiments, the hybridized graft copolymer powder is added to the disclosed photopolymerizable liquid to enable good adhesion while allowing for removal under recycle conditions.

### Oligomers (Optional)

Compositions disclosed herein optionally include oligomers. Although adding oligomers to the composition are typically unnecessary with the addition of the hybridized graft copolymer component, oligomers may still be desired to achieve certain properties of the cured ink or coating. Typically, oligomers have molecular weights of from about 500-20,000 g/mol and provide film properties superior to what can be achieve with monomers alone. The oligomer may be the same chemical composition of the reactive diluent monomer except partially reacted to an extent lesser than forming a polymer. Non-limiting examples of suitable oligomer classes for use in the disclosed compositions include epoxy acrylates, aliphatic urethane acrylates, aromatic urethane acrylates, polyester acrylates and acrylic acrylates.

In general, the oligomer is selected based on its physical characteristics to enable increased reactivity, hardness, chemical resistance and reduced cost (epoxy acrylates); increase flexibility, toughness, weathering (aliphatic urethane arylate); increase flexibility and toughness (aromatic urethane acrylate); increase wetting with decreased viscosity (polyester acrylate) or increase adhesion and weathering (acrylic acrylate). This allows for a formulation to be tuned to the desired specification for the application where it is being used.

In some embodiments, oligomers for use in connection with the disclosed compositions are reduced in concentration or altogether eliminated through incorporation of the hybridized graft copolymer resin. Advantageously, it has been found that combination of the graft copolymer with various oligomers enables the benefits of the oligomer to be imparted to the composition or end coating application at reduced concentration or the complete elimination of the oligomer without the loss of coating properties.

In the compositions disclosed herein, adhesion benefits can be achieved with zero or very small loadings of the oligomer in the composition such as, e.g., about 1 wt % or less, about 5 wt % or less, about 20 wt % or less, about 30 wt % or less, about 40 wt % or less, about 50 wt % or less, about 60 wt % or less, based on the total weight of the composition (e.g., the total weight of a photopolymerizable composition). Producing compositions with a relatively low amount of oligomer can lead to viscosity reduction of the composition, advantageously enabling new, unique properties to be formulated into the coating, including the ability to remove a coating with good adhesion easily in the recycle stream.

### Photoinitiator (Optional)

The disclosed compositions often include at least one photoinitiator (photopolymerization initiator). For example, a photoinitiator is not necessary to include in a composition to be cured by E-beam radiation but is typically necessary if the composition is to be cured by UV radiation.

A photoinitiator has a function of accelerating the polymerization reaction of the photocurable resin composition due to light irradiation (e.g., ultraviolet light irradiation). The photoinitiator can be blended in a proportion of, for example, 0.1% by weight to 20% by weight with respect to the total weight of the photocurable composition. Depending on the level and speed of cure desired, the photoinitiator may be used at various concentrations, e.g., 0.1 wt % or less, 1 wt % or less, 3 wt % or less, 5 wt % or less, 7 wt % or less, 10 wt % or less, 12 wt % or less, 15 wt % or less, 17 wt % or less, 20 wt % or less, based on the total weight of the composition.

Two main types of free radical initiators are known: Type 1 and Type 2. Type 1 photoinitiators generate two radicals upon exposure to light through a cleavage reaction. Only one of these radicals typically initiates the reaction and so often Type 1 photoinitiators have issues with radical migration. An example of a Type 1 photoinitiator is 1-hydroxy-cyclohexylphenyl-ketone. Type 2 photoinitiators abstract an electron from a synergist molecule, which then acts as the initiating species for the photopolymerization. An example of a Type 2 photoinitiator is benzophenone. Broadly, classes of photoinitiators include benzophenones, α-hydroxy ketones, benzyl-dialkylketal, α-amino ketones, phenyl glyoxylates, thioxanthones and acylphosphine oxides. Non-limiting examples of suitable photoinitiators for use in the disclosed compositions include benzophenone (Genocure BP), 1-hydroxy-cyclohexyl-phenyl-ketone (Irgacure 184), 2-hydroxy-1-[4-(2-hydroxyethoxy) phenyl]-2-methyl-1-propanone (Irgacure 2959), 2-hydroxy-2-methyl-1-phenyl-1-propanone (Darocure 1173), a, α-Dimethoxy-α-phenylacetophenone (Irgacure 651), 2-benzyl-2-dimethylamino-1-[4-(4-morpholinyl) phenyl]-1-butanone (Irgacure 369), methyl-benzoyl-formate (Genocure MBF), Isopropyl-thioxanthone (Genocure ITX), 2,4,6-trimethyl-benzoyl)-diphenyl phosphine oxide (Lucirin TPO), and phenyl-bis-(2,4,6-trimethylbenzoyl) phosphine oxide (Irgacure 819).

In the compositions disclosed herein, either Type 1 or Type 2 photoinitiators can be included in compositions designed for UV light exposure.

### Colorant (Optional)

When the compositions disclosed herein are used as inks such as, for example, inkjet ink, they may comprise a colorant. The colorant may be a dye or a pigment or a mixture thereof, collectively referred to herein as a “pigment”). Ink jet ink is used in inkjet printers that create an image by propelling droplets of such ink onto a substrate. The jet ink as herein may be used within the continuous inkjet technology, thermal drop-on-demand technology, or piezoelectric drop-on-demand technology.

A liquid composition of the present invention may comprise some weight percent of a pigment or a dye, e.g., about 1 wt % or less, about 2 wt % or less, about 5 wt % or less, about 10 wt % or less, about 15 wt % or less, about 20 wt %, about 25 wt % or less based on the total weight of the composition. The pigment as used in the liquid ink is not particularly limited, and any of an inorganic pigment and an organic pigment may be used. Examples of the inorganic pigment include titanium oxide and iron oxide. Further, a carbon black produced by a known method such as a contact method, a furnace method, or a thermal method can be used.

Examples of an organic pigment include an azo pigment (such as an azo lake pigment, an insoluble azo pigment, a condensed azo pigment, or a chelate azo pigment), a polycyclic pigment (such as a phthalocyanine pigment, a perylene pigment, a perinone pigment, an anthraquinone pigment, a quinacridone pigment, a dioxazine pigment, a thioindigo pigment, an isoindolinone pigment, or a quinophthalone pigment), a dye chelate (such as a basic dye type chelate, or an acid dye type chelate), a nitro pigment, a nitroso pigment, Aniline Black or the like can be used.

Specific examples of the carbon black which may be used as the black ink include No. 2300, No. 900, MCF88, No. 33, No. 40, No. 45, No. 52, MA7, MA8, MA100, and No. 2200B (all of which are manufactured by Mitsubishi Chemical Corporation), Raven 5750, Raven 5250, Raven 5000, Raven 3500, Raven 1255, and Raven 700 (all of which are manufactured by Columbian Chemicals Company), Regal 400R, Regal 330R, Regal 660R, Mogul L, Monarch 700, Monarch 800, Monarch 880, Monarch 900, Monarch 1000, Monarch 1100, Monarch 1300, and Monarch 1400 (all of which are manufactured by Cabot Corporation), and Color Black FW1, Color Black FW2, Color Black FW2V, Color Black FW18, Color Black FW200, Color Black 5150, Color Black S160, Color Black S170, Printex 35, Printex U, Printex V, Printex 1400, Special Black 6, Special Black 5, Special Black 4A, and Special Black 4 (all of which are manufactured by Degussa AG).

Specific examples of the pigment which is used in the yellow ink include C.I. Pigment Yellow 1, C.I. Pigment Yellow 2, C.I. Pigment Yellow 3, C.I. Pigment Yellow 12, C.I. Pigment Yellow 13, C.I. Pigment Yellow 14C, C.I. Pigment Yellow 16, C.I. Pigment Yellow 17, C.I. Pigment Yellow 73, C.I. Pigment Yellow 74, C.I. Pigment Yellow 75, C.I. Pigment Yellow 83, C.I. Pigment Yellow 93, C.I. Pigment Yellow 95, C.I. Pigment Yellow 97, C.I. Pigment Yellow 98, C.I. Pigment Yellow 109, C.I. Pigment Yellow 110, C.I. Pigment Yellow 114, C.I. Pigment Yellow 128, C.I. Pigment Yellow 129, C.I. Pigment Yellow 138, C.I. Pigment Yellow 150, C.I. Pigment Yellow 151, C.I. Pigment Yellow 154, C.I. Pigment Yellow 155, C.I. Pigment Yellow 180, and C.I. Pigment Yellow 185.

Specific examples of the pigment which is used in the magenta ink include C.I. Pigment Red 5, C.I. Pigment Red 7, C.I. Pigment Red 12, C.I. Pigment Red 48(Ca), C.I. Pigment Red 48(Mn), C.I. Pigment Red 57(Ca), C.I. Pigment Red 57:1, C.I. Pigment Red 112, C.I. Pigment Red 122, C.I. Pigment Red 123, C.I. Pigment Red 168, C.I. Pigment Red 184, C.I. Pigment Red 202, and C.I. Pigment Violet 19.

Specific examples of the pigment which is used in the cyan ink include C.I. Pigment Blue 1, C.I. Pigment Blue 2, C.I. Pigment Blue 3, C.I. Pigment Blue 15:3, C.I. Pigment Blue 15:4, C.I. Pigment Blue 15:34, C.I. Pigment Blue 16, C.I. Pigment Blue 22, C.I. Pigment Blue 60, C.I. Vat Blue 4, and C.I. Vat Blue 60.

The compositions disclosed herein may be applied to any substrate on which inks and coatings are typically applied, including porous materials. Upon application of ink droplets onto a porous substrate, the ink wets the substrate, the ink penetrates into the substrate, volatile components of the ink evaporate, leaving a dry mark on the substrate. Examples of porous substrates include paper, paperboard, cardboard, woven fabrics, and non-woven fabrics.

The compositions disclosed herein may be also successfully applied to non-porous substrates. Examples of non-porous substrates include glossy coated paper, glass, ceramics, polymeric substrate, and metal.

Compositions disclosed herein are particularly suitable for use on polymeric substrates. Examples of polymeric substrates include polyolefin, polystyrene, polyvinyl chloride, nylon, polyethylene terephthalate, high-density polyethylene, low-density polyethylene, polypropylene, polyester, polyvinylidene chloride, urea-formaldehyde, polyamides, high impact polystyrene, polycarbonate, polyurethane, phenol formaldehyde, melamine formaldehyde, polyetheretherketone, polyetherimide, polylactic acid, polymethyl methacrylate, and polytetrafluoroethylene.

Compositions disclosed herein are also suitable for use on metal substrates. Examples of metal substrates include base metals, ferrous metals, precious metals, noble metals, copper, aluminum, steel, zinc, tin, lead, and any alloys thereof.

Compositions disclosed herein are also suitable for use of high surface energy substrates. Examples of high surface energy substrates include phenolic, Nylon, alkyd enamel, polyester, epoxy, polyurethane, acrylonitrile butadiene styrene copolymer, polycarbonate, rigid polyvinyl chloride, and acrylic.

Compositions disclosed herein are also suitable for use of low surface energy substrates. Examples of low surface energy substrates include polyvinyl alcohol, polystyrene, acetal, ethylene-vinyl acetate, polyethylene, polypropylene, polyvinyl fluoride, and polytetrafluoroethylene. Upon application to a low energy substrate, the volatizable components of the ink evaporate to yield a coating on the substrate. Such a coating is resistant to water or cleaning solvents.

One or more additional components may optionally be included in the compositions for making the disclosed photopolymerizable liquid compositions. A coating composition disclosed herein may contain one or more additives or fillers known in the art for use in photopolymerizable coatings. Such additives or fillers include, but are not limited to, extenders; pigment wetting and dispersing agents and surfactants; anti-settling, anti-sag and bodying agents; anti-flooding and anti-floating agents; fungicides and mildewcides; corrosion inhibitors; thickening agents; or plasticizers. Specific examples of such additives can be found in Raw Materials Index, published by the National Paint & Coatings Association, 1500 Rhode Island Avenue, NW, Washington, D.C. 20005. Non-limiting examples of suitable colorants include dyes (e.g., solvent red 135), organic pigments (pigment blue 15:1), inorganic pigments (e.g., iron oxide pigment red 101), effect pigments (e.g., aluminum flake), or combinations thereof.

Also disclosed herein is a method for printing or applying a coating on a substrate, the method comprising the steps of applying to a substrate a photocurable composition comprising at least one reactive diluent monomer; a hybridized graft copolymer dissolved in the at least one reactive diluent monomer, wherein the hybridized graft copolymer comprises: (a) a hydrophobic functional polymeric backbone, wherein the backbone comprises (i) an acrylate polymer, an alkylacrylate polymer, a siloxane polymer, a olefin polymer, a functional vinyl polymer, or a mixture of these functionalities, wherein the backbone has an average molecular weight (Mₙ) of from about 3,000 to about 200,000 g/mol; and b) a plurality of hydrophilic polymeric side chains attached to the hydrophobic functional polymeric backbone, wherein the hydrophilic polymeric side chains comprise a polymerization product of at least one polymerizable unsaturated monomer and a polymerizable amine-containing unsaturated monomer; optionally, at least one colorant selected from the group consisting of a dye and a pigment; optionally, at least one oligomer; and optionally, at least one photoinitiator; and curing the applied composition. Any of the aforementioned substrates can be used in the method of the present invention. The compositions can be applied by drawing, rolling, spraying, printing, or any other method of applying a photocurable composition to a substrate. The photocurable compositions applied to substrates have improved adhesion, resistance to mechanical abrasion, and are readily recyclable as illustrated in the Examples that follow which are provided for the purpose of further illustrating the present invention but are by no means intended to limit the same.

### EXAMPLES

The disclosed technology is next described by means of the following examples. The use of these and other examples anywhere in the specification is illustrative only, and in no way limits the scope and meaning of the invention or of any exemplified form. Likewise, the invention is not limited to any particular preferred embodiments described herein. Indeed, modifications and variations of the invention may be apparent to those skilled in the art upon reading this specification and can be made without departing from its spirit and scope. The invention is therefore to be limited only by the terms of the claims, along with the full scope of equivalents to which the claims are entitled.

### Example 1

One of the hybridized graft copolymers used for the following experiments is presented in Example 1. The chemical synthesis of this material is described in detail above and in U.S. Pat. No. 9,441,123 and PCT/US2020/025344. Briefly, a hydrophobic polymer backbone of UMOH terpolymer of polyvinylchloride-r-polyacetate-r-polyvinyl alcohol with a molecular weight of about 27,000 g/mol was reacted with hydrophilic sidechains consisting of random copolymers of poly(methyl methacrylate)-r-poly(hydroxyethyl acrylate)-r-poly(isobornyl methacrylate)-r-poly(di-methyl aminoethyl methacrylate)-r-poly(1-(2-hydroxyethyl)-2-imidazolidinone methacrylate) with a molecular weight of about 3,000 g/mol. The ratio of hydrophobic backbone polymer to hydrophilic side chains was 87 weight percent backbone to 13 weight percent side chains.

### Example 2

A second hybridized graft copolymer used for the following experiments is presented in Example 2. The chemical synthesis of this material is described in detail in above and in PCT/US2020/025344. Briefly, a hydrophobic polymer backbone consisting of poly(butyl methacrylate)-r-poly(2-hydroxyethyl methacrylate) with a molecular weight of about 29,000 g/mol was reacted with hydrophilic sidechains consisting of random copolymers of poly(methyl methacrylate)-r-poly(isobornyl methacrylate)-r-poly(di-methyl aminoethyl methacrylate)-r-poly(1-(2-hydroxyethyl)-2-imidazolidinone methacrylate) with a molecular weight of about 3,000 g/mol. The ratio of hydrophobic backbone polymer to hydrophilic side chains was 87 weight percent backbone to 13 weight percent side chains.

### Example 3

In this example, the hybridized graft copolymer resin from Examples 1 and 2 were incorporated into a commercially available cyan UV curable ink procured from EFI. The graft copolymers were dissolved in butyl methacrylate at a 1:2.4 ratio and then added to the ink at 15 wt % based on the concentration of the graft copolymers. Sample 1 contains the graft copolymer from Example 1. Sample 2 contains the graft copolymer of Example 2. The control and test formulations were applied via drawdown using a #11 wire wound rod and then cured using a mercury lamp at an identical distance and residence time as any controls. The drawdowns were applied to multiple substrates with a wide range of surface energies, including polyethylene terephthalate (PET), polypropylene (PP), high-density polyethylene (HDPE), aluminum, steel and glass. Adhesion of the films on the substrates was tested with a Cross Cut Tape Test according to standards set in ISO 2409 and ASTM D3359 Method B.

TABLE 1
Adhesion results for multiple substrates for a control and samples
containing the hybridized graft copolymer of Example 1 (Sample
1) and Example 2 (Sample 2).

| | Pre-treatment? | Adhesion Measurement | | |
|---|---|---|---|---|
| Substrate | (Y/N) | Control | Sample 1 | Sample 2 |
| Aluminum | N | 5B | 5B | — |
| Steel | N | 0B | 5B | — |
| Glass | N | 0B | 5B | — |
| PET | N | 0B | 5B | 5B |
| PP | N | 0B | 0B | — |
| PP | Y | 0B | 4B | — |
| HDPE | N | 0B | 0B | — |
| HDPE | Y | 0B | 4B | — |

Table 1 shows improved adhesion across the board for Sample 1, as the only substrate that the commercial material would adhere to prior to the addition of the hybridized graft copolymer resin was the aluminum whereas Sample 1 showed adhesion >4B on all substrates excluding untreated polyethylene and polypropylene. Similar results on PET were obtained for Sample 2, as the sample showed 5B adhesion.

### Example 4

In this example, the hybridized graft copolymer resin of Example 1 was added to a black UV curable ink formulation at 1.8 wt % after being dissolved in BMA (see control and test formulations in Table 2). A white UV curable ink (Penn Color product code 9W2148) was drawn down onto a glass microscope slide with a #11 wire wound rod and then cured using a mercury lamp at an identical distance and residence time as any controls. The black ink was then drawn down on top of the cured white coating in the exact same fashion. Scratch resistance and adhesion was tested using ASTM D-3363 for hardness and resistance to scratches and wear using a pencil of “H” hardness.

TABLE 2
Control and test formulations of the black ink tested for scratch resistance

| Material | Control | Sample 3 |
|---|---|---|
| 9B1088 | 7.2 | 7.2 |
| 9C1801 | 92.8 | 85.6 |
| Graft Copolymer | 0.0 | 1.8 |
| BMA | 0.0 | 2.2 |

Surprisingly, the sample containing the hybridized graft copolymer improved the scratch resistance of the black film significantly. Typically, BMA is a material that cures softer, so the graft copolymer is not only improving the performance of the coating formula itself but also overcoming the addition of the BMA. This experiment also indicates that the graft copolymer also enhances adhesion, as the black coating in the control scratched off but the white coating did not scratch off of the glass, indicating an adhesion failure of the black coating to the white. Obviously, there is no such failure for Sample 3.

### Example 5

In this example, the hybridized graft copolymer resin of Example 1 was added to a relatively simple UV curable formula as a substitute for a significant amount of oligomer content. The formula is shown in Table 3 and the oligomer content was reduced from 66.8 wt % to 17.3 wt % and the balance made up with low viscosity reactive diluents (BMA and Photomer 4361-P) and the graft copolymer.

TABLE 3
Formulations for control and Sample 3 comparison.

| | Viscosity at | | | Sample |
|---|---|---|---|---|
| Material | 25° C. (cP) | Function | Control | 4 |
| BMA | 0.86 | Monomer | 0.0 | 12.4 |
| Photomer 4361-P | 15 | Monomer | 0.0 | 29.6 |
| Ebecryl 284 | 1900-2300* | Oligomer | 30.2 | 7.8 |
| Ebecryl 265 | 2700-3300* | Oligomer | 34.3 | 8.9 |
| Ebecryl 350 | 200-500 | Oligomer | 2.4 | 0.6 |
| Tinuvin PA 123 | 2900-3100 | UV protection | 3.6 | 0.9 |
| Genorad 16 | 1200 | Anaerobic | 7.2 | 1.9 |
| | | stabilizer | | |
| 9R1216 | — | Color tint | 12.4 | 12.4 |
| Darocure 4265 | — | Photoinitiator | 6.0 | 6.0 |
| Irgacure 500 | 90 | Photoinitiator | 4.0 | 4.0 |
| Graft Copolymer | — | Test Parameter | 0.0 | 15.5 |

*Viscosity specified at 60° C.

These inks were then applied on to a pre-coated glass substrate. The glass substrate was coated with a separate UV coating that did not contain the graft copolymer. The formulated UV coatings were then drawn down using a #11 wire wound rod and then cured using a mercury lamp at an identical distance and residence time as any controls. These coatings were then subject to a solvent resistance test, which consisted of applying a small amount of solvent onto the coating and then lightly rubbing the wet film with a cotton swab. The test was conducted with methyl ethyl ketone (MEK), ethyl alcohol (EtOH), and isopropyl alcohol (IPA).

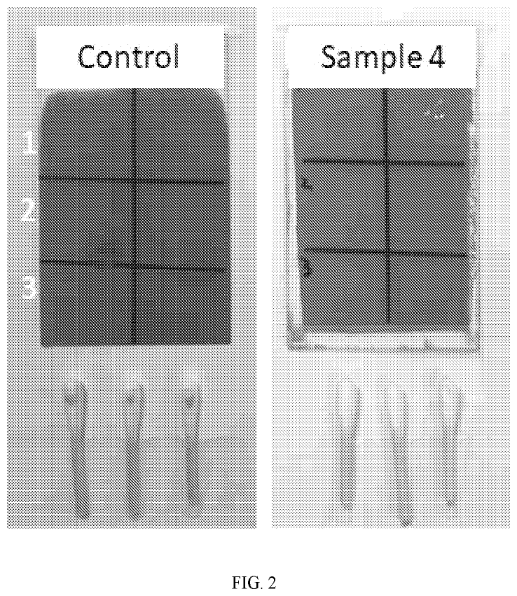

FIG. 2 shows the solvent resistance results for these coatings. There is obvious red color on the swabs for the control sample while there is no red for the cotton swabs used for the sample containing the graft copolymer. Note that the squares marked (1), (2) and (3) correspond to MEK, EtOH and IPA, respectively.

### Example 6

This example compares the performance of the hybridized graph copolymer of Example 1 and Example 2 with that of a surfactant or adhesion promoter common to the industry. The control and test formulations (Samples 5-8) were applied via drawdown using a #11 wire wound rod and then cured using a mercury lamp at an identical distance and residence time as any controls. Those formulations are shown in Table 4.

TABLE 4
Control formulation, a formulation with added surfactant (Sample 5,
TegoWet 270), a formulation with an adhesion promoter (Sample 6,
Isocryl AM-2), a formulation with the graft copolymer from
Example 1 (Sample 7) and a formulation with the graft copolymer
form Example 2 (Sample 8).

| Material | Control | Sample 5 | Sample 6 | Sample 7 | Sample 8 |
|---|---|---|---|---|---|
| HDODA | 30.6 | 9.0 | 33.3 | 35.6 | 35.6 |
| Ebecryl 284 | 32.0 | 0.0 | 0.0 | 16.5 | 16.5 |
| Miramer M2100 | 0.0 | 20.0 | 15.7 | 0.0 | 0.0 |
| Irgacure 500 | 7.0 | 7.0 | 3.8 | 3.5 | 3.5 |
| Darocure 4265 | 3.0 | 0.0 | 5.7 | 1.5 | 1.5 |
| Photoinitiator | | | | | |
| Penn Color | 15.0 | 20.0 | 14.3 | 15.0 | 15.0 |
| Dispersion | | | | | |
| 9R1216 | | | | | |
| Graft Copolymer | 0.0 | 0.0 | 0.0 | 15.5 | 0.0 |
| (Example 1) | | | | | |
| Graft Copolymer | 0.0 | 0.0 | 0.0 | 0.0 | 15.5 |
| (Example 2) | | | | | |
| Isocryl AM-2 | 0.0 | 0.0 | 14.8 | 0.0 | 0.0 |
| TegoWet 270 | 0.0 | 1.0 | 0.0 | 0.0 | 0.0 |
| Ebecryl 350 | 0.0 | 0.0 | 0.6 | 0.0 | 0.0 |
| Butyl | 12.4 | 43.0 | 11.8 | 12.4 | 12.4 |
| Methacrylate | | | | | |
| (BMA) | | | | | |

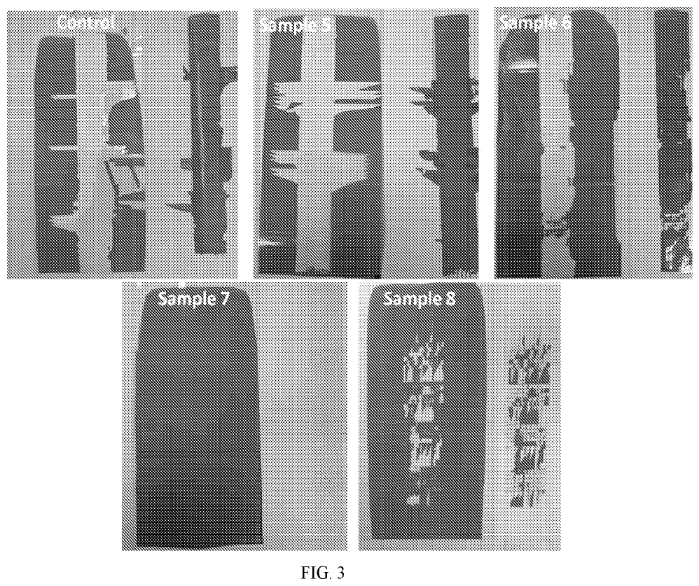

The drawdowns were applied to polyethylene terepthalate (PET) substrates and adhesion of the films to the substrates was tested with a Cross Cut Tape Test according to standards set in ISO 2409 and ASTM D3359 Method B, shown in FIG. 3.

The control sample and samples containing the surfactant and adhesion promoter (Samples 5 and 6) each showed complete adhesion failure when the tape was pulled. Sample 7—containing the graft copolymer from Example 1—showed 5B adhesion on the PET substrate while sample 8—containing the graft copolymer from Example 2—showed 2B adhesion.

### Example 7

This example illustrates the ability to replace oligomeric formulation components from a digitally printable formulation, lower the viscosity and increase the adhesion of the print. The formulations for this experiment are shown in Table 5 and the hybridized graft copolymer used is from Example 1.

TABLE 5
Digital formulations, Control versus Sample 9 with no oligomer.

| Material | Function | Control | Sample 9 |
|---|---|---|---|
| Miramir M2100 | Oligomer | 35.0 | 0.0 |
| Irgacure 500 | Photoinitiator | 10.5 | 7.0 |
| Darocure 4265 | Photoinitiator | 4.5 | 3.0 |
| 9R445 | ColorTint | 15.0 | 15.0 |
| BMA | Reactive Diluent | 35.0 | 70.0 |
| Graft Copolymer | Test Parameter | 0.0 | 5.0 |

Viscosities of the inks were measured at 25° C., and the viscosity of the control ink (18 cP) was more than of the test ink (Sample 9, 9 cP), illustrating that removal of the oligomeric material does significantly reduce the viscosity.

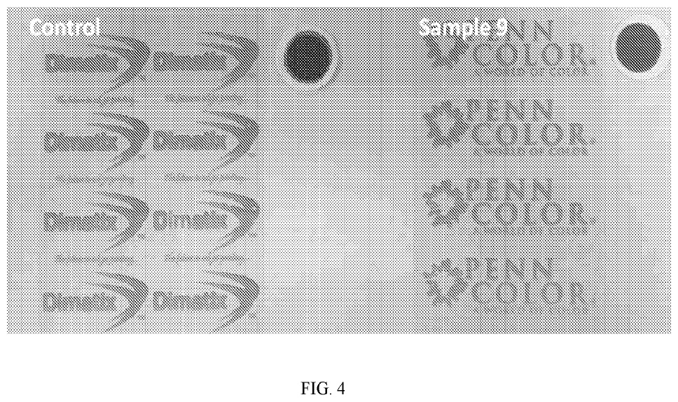

The UV inks were then printed onto multiple substrates (PET, Aluminum, and Steel) using a Dimatix DMP printer. They were each printed using a pattern rather than solid blocks to ensure there were edges that could grab the tape used to test adhesion. These prints are shown in FIG. 4.

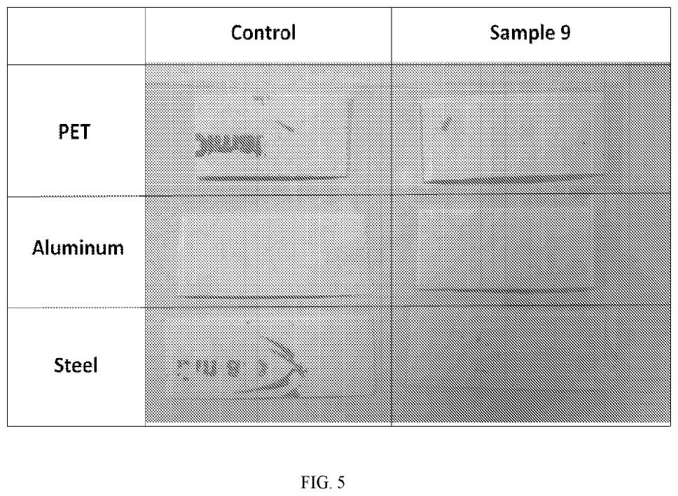

Adhesion was then tested on each substrate by pressing down laboratory masking tape and securing by rubbing a thumb over the tape 5 times each, exerting maximum pressure with each rub. FIG. 5 shows that the formulation containing the graft copolymer had identical adhesion performance to the control formulation on aluminum and outperformed the control formulation significantly on steel and PET.

### Example 8

This example shows that the addition of the hybridized graft copolymer resin from Example 1 improves the recyclability of a film applied to a PET substrate. The same ink formulas used in Sample 9 were used, except that the concentration of the graft copolymer was increased to 7.5 wt % and the BMA was subsequently reduced by 2.5% (denoted Sample 10).

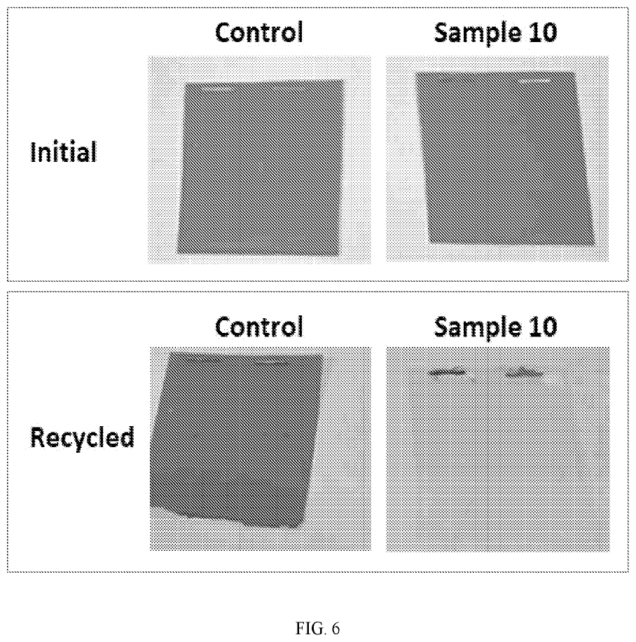

The formulas were drawn down on untreated Mylar film (PET) using a #11 wire wound rod and then cured using a mercury lamp. The coated films then underwent testing to remove the ink using APR critical guidance for the “Protocol for Producing PET Flake for Evaluation and Evaluating for Discoloration from Bleeding Labels”. Ink coated samples were submerged and agitated at 600 rpm in a 0.25M KOH solution containing 3% Triton 100× at 90° C. for 15 minutes. Afterwards they were removed from the wash water and evaluated for ink loss and are shown in FIG. 6.

Sample 10 is completely removed from the PET under recycle conditions while the control is not removed at all. Additionally, the material that comes off of the PET comes off in flakes that are more dense than the recycle wash and do not contribute any color to the wash solution, meaning that the components in the formulation can be easily removed and reduce or eliminate the need to treat the wash solution after recycle.

### Example 9

This example shows that addition of the hybridized graft copolymer of Example 1 increases the bond strength between two surfaces with dissimilar surface energies. The same formulations as used in Sample 10 were used for these experiments.

The control and sample formulations were drawn down using a #11 wire wound rod onto a vinyl substrate. A PET film was then pressed onto the uncured liquid, ensuring wet-out of both films. The film was then cured, and the bond strength was measured using a Instron ESM-303. The load was measured as a function of distance, giving an average, minimum and maximum bond strength per surface area. The same films were then laminated for 2 minutes at 275° F. and 6,000 psi and bond strengths were measured again.

TABLE 6
Bond strength measurements of films with and without the hybridized
graft copolymer of Example 1.

| | Average | | | |
|---|---|---|---|---|
| | Force | Standard | Minimum | Maximum |
| Sample Name | (Ibs/in²) | Deviation | (lbs/in²) | (lbs/in²) |
| Control—UV Only | 0.099 | 0.003 | 0.06 | 0.1 |
| Sample 10—UV Only | 1.028 | 0.197 | 0.4 | 1.24 |
| Control—UV + Laminate | 0.162 | 0.017 | 0.12 | 0.2 |
| Sample 10—UV + Laminate | 2.290 | 0.318 | 0.44 | 3.04 |

Table 6 shows an increase in bond strength, both before and after lamination. For the control samples, there was virtually no force needed to peel the two substrates apart, which is to be expected for a cured film. Surprisingly, there was a significant bond strength between the two substrates with the Sample 10 coating between them, making it difficult to separate the materials. Also, surprisingly, while there was no increase in bond strength after lamination for the control sample, the bond strength more than doubled for the Sample 10 formulation. Typically, we would expect there to be no increase because the cured film is a thermoset that does not appreciably relax upon the lamination conditions, but the hybridized graft copolymer from Example 1 brings additional value when laminated.

We claim:

1. A photopolymerizable liquid composition comprising:
at least one reactive diluent monomer;
a hybridized graft copolymer dissolved in the at least one reactive diluent monomer, wherein the hybridized graft copolymer comprises:
(a) a hydrophobic functional polymeric backbone, wherein the backbone comprises (i) an acrylate polymer, an alkylacrylate polymer, a siloxane polymer, a olefin polymer, a functional vinyl polymer, or a mixture of these functionalities, wherein the backbone has an average molecular weight (Mₙ) of from about 3,000 to about 200,000 g/mol; and
b) a plurality of hydrophilic polymeric side chains attached to the hydrophobic functional polymeric backbone, wherein the hydrophilic polymeric side chains comprise a polymerization product of at least one polymerizable unsaturated monomer and a polymerizable amine-containing unsaturated monomer;
optionally, at least one colorant selected from the group consisting of a dye and a pigment;
optionally, at least one oligomer; and
optionally, at least one photoinitiator.

2. The composition of claim 1, wherein the hydrophobic functional polymeric backbone comprises from about 5 weight percent to about 95 weight percent of the hybridized graft copolymer.

3. The composition of claim 1, wherein the backbone of the hybridized graft copolymer comprises a functional vinyl chloride-containing polymer portion having an average molecular weight (Mₙ) of from about 3,000 to about 200,000 g/mol.

4. The composition of claim 1, wherein the backbone of the hybridized graft copolymer comprises a hydroxy functional vinyl chloride-vinyl acetate-vinyl alcohol terpolymer portion having an average molecular weight (Mₙ) of from about 3,000 to about 200,000 g/mol.

5. The composition of claim 1, wherein the hydrophobic functional polymeric backbone comprises one selected from the group consisting of an acrylate polymer, an alkylacrylate polymer, and both an acrylate polymer and an alkylacrylate polymer having an average molecular weight (Mₙ) of from about 3,000 to about 200,000 g/mol.

6. The composition of claim 1, wherein the hydrophobic functional polymeric backbone comprises an alkylacrylate polymer having an average molecular weight (Mₙ) of from about 3,000 to about 200,000 g/mol.

7. The composition of claim 1, wherein the hydrophobic functional polymeric backbone comprises an acrylate polymer having an average molecular weight (Mₙ) of from about 3,000 to about 200,000 g/mol.

8. The composition of claim 1, wherein the hydrophobic functional polymeric backbone comprises an acrylate polymer and an alkylacrylate polymer having an average molecular weight (Mₙ) of from about 3,000 to about 200,000 g/mol.

9. The composition of claim 1, wherein the hydrophobic functional polymeric backbone is selected from the group consisting of a hydroxy functional polybutyl acrylate, a hydroxy functional polyethyl hexyl acrylate, a hydroxy functional polyethyl acrylate, a hydroxy functional polymethyl methacrylate, and combinations of two or more thereof having an average molecular weight (Mₙ) of from about 3,000 to about 200,000 g/mol.

10. The composition of claim 1, wherein a plurality of hydrophilic polymeric side chains are attached to the hydrophobic functional polymeric backbone, wherein the hydrophilic side chains comprise a reaction product of at least (i) one polymerizable unsaturated monomer (ii) at least one polymerizable amine-containing unsaturated monomer selected from the group consisting of dimethylaminoethyl methacrylate, and 1-(2-hydroxyethyl)-2-imidazolidinone methacrylate.

11. The composition of claim 1, wherein a plurality of hydrophilic polymeric side chains are attached to the hydrophobic functional polymeric backbone, wherein the hydrophilic side chains comprise a reaction product of at least (i) a polymerizable unsaturated monomer selected from the group consisting of: hydroxyethyl acrylate, isobornyl methacrylate, and methyl methacrylate, and (ii) at least one polymerizable amine-containing unsaturated monomer.

12. The composition of claim 1, wherein a plurality of hydrophilic polymeric side chains are attached to the hydrophobic functional polymeric backbone, wherein the hydrophilic side chains comprise a reaction product of at least (i) a polymerizable unsaturated monomer selected from the group consisting of: hydroxyethyl acrylate, isobornyl methacrylate, and methyl methacrylate, and (ii) at least one a polymerizable unsaturated monomer selected from the group consisting of an amine-containing acrylate, an amine-containing methacrylate, an acrylamide, a methacrylamide, and an amine-containing unsaturated monomer.

13. The composition of claim 1, wherein a plurality of hydrophilic polymeric side chains are attached to the hydrophobic functional polymeric backbone, wherein the hydrophilic side chains comprise a reaction product of at least (i) a polymerizable unsaturated monomer selected from the group consisting of: hydroxyethyl acrylate, isobornyl methacrylate, and methyl methacrylate, and (ii) at least one a polymerizable unsaturated monomer selected from the group consisting of t-butylaminoethyl methacrylate, 2-dimethylaminoethyl methacrylate, and 1-(2-methacryloyloxyethyl)-2-imidazolidinone.

14. The composition of claim 1, wherein a plurality of hydrophilic polymeric side chains are attached to the hydrophobic functional polymeric backbone, wherein the hydrophilic side chains comprise a reaction product of at least (i) a polymerizable unsaturated monomer selected from the group consisting of: hydroxyethyl acrylate, isobornyl methacrylate, and methyl methacrylate, and (ii) at least one polymerizable amine-containing unsaturated monomer selected from the group consisting of dimethylaminoethyl methacrylate, and 1-(2-hydroxyethyl)-2-imidazolidinone methacrylate.

15. The composition of claim 1 wherein the hybridized graft copolymer comprises:
(a) a hydrophobic functional polymeric backbone comprising a hydroxy functional vinyl chloride-vinyl acetate-vinyl alcohol terpolymer portion having an average molecular weight (Mₙ) of from about 15,000 to about 50,000 g/mol; and
(b) a plurality of hydrophilic polymeric side chains reacted onto the hydrophobic functional polymeric backbone, wherein the hydrophilic side chains comprise a reaction product of at least (i) a polymerizable unsaturated monomer selected from the group consisting of: hydroxyethyl acrylate, isobornyl methacrylate, and methyl methacrylate, and (ii) at least one a polymerizable amine-containing unsaturated monomer selected from the group consisting of dimethylaminoethyl methacrylate, and 1-(2-hydroxyethyl)-2-imidazolidinone methacrylate,
wherein the hydrophobic functional polymeric backbone comprises from about 5 weight percent to about 95 weight percent of the hybridized copolymer.

16. The composition of claim 1 wherein the hybridized graft copolymer comprises:
(a) a hydrophobic functional polymeric backbone comprising a polymer selected from the group consisting of a hydroxy functional polybutyl acrylate, a hydroxy functional polyethyl hexyl acrylate, a hydroxy functional polyethyl acrylate, a hydroxy functional polymethyl methacrylate, and combinations of two or more thereof having an average molecular weight (Mₙ) of from about 15,000 to about 50,000 g/mol; and
(b) a plurality of hydrophilic polymeric side chains reacted onto the hydrophobic functional polymeric backbone, wherein the hydrophilic side chains comprise a reaction product of at least (i) a polymerizable unsaturated monomer selected from the group consisting of: hydroxyethyl acrylate, isobornyl methacrylate, and methyl methacrylate, and (ii) at least one a polymerizable amine-containing unsaturated monomer selected from the group consisting of dimethylaminoethyl methacrylate, and 1-(2-hydroxyethyl)-2-imidazolidinone methacrylate,
wherein the hydrophobic functional polymeric backbone comprises from about 5 weight percent to about 95 weight percent of the hybridized copolymer.

17. The composition of claim 1, wherein the hydrophobic functional polymeric backbone comprises a functional polyolefin.

18. The composition of claim 1, wherein the hydrophobic functional polymeric backbone comprises a functional polysiloxane.

19. The composition of claim 1, wherein the composition comprises from about 0.10 to about 16 wt. % of the hybridized graft copolymer, based on the total weight of the composition.

20. The composition of claim 1, wherein at least one reactive diluent monomer is selected from the group consisting of an acrylate, a methacrylate, a styrene, a caprolactam, a pyrrolidone, a formamide, a silane, and a vinyl ether.

21. The composition of claim 1, wherein the at least one reactive diluent is an alkyl (meth)acrylate selected from the group consisting of methyl (meth)acrylate, ethyl (meth)acrylate, n-propyl (meth)acrylate, isopropyl (meth)acrylate, isobutyl (meth)acrylate, tert-butyl (meth)acrylate, n-pentyl (meth)acrylate, n-hexyl (meth)acrylate, n-heptyl (meth)acrylate, n-octyl (meth)acrylate, isooctyl (meth)acrylate, 2-ethylhexyl (meth)acrylate, n-nonyl (meth)acrylate, isononyl (meth)acrylate, decyl (meth)acrylate, lauryl (meth)acrylate, stearyl (meth)acrylate, isophoryl acrylate, isodecyl acrylate, tridecyl acrylate, lauryl acrylate, 2-(2-ethoxy-ethoxy)ethyl acrylate, tetrahydrofurfuryl acrylate, propoxylated acrylate, tetrahydrofurfuryl methacrylate, 2-phenoxyethyl methacrylate, isobornyl methacrylate, 3,3,5-trimethylcyclohexyl methacrylate, octyl decyl acrylate, tridecyl acrylate, isodecyl methacrylate, stearyl acrylate, stearyl methacrylate, 1,12 dodecane diol diacrylate, 1,3-butylene glycol diacrylate, 1,4-butanediol diacrylate, 1,6-hexanediol diacrylate, alkoxylated hexanediol diacrylate, alkoxylated neopentyl glycol diacrylate, cyclohexane dimethanol diacrylate, diethylene glycol diacrylate, phenoxyethyl acrylate (POEA), 4-t-butylcyclohexyll acrylate, butyl methacrylate (BMA), 2-(acetoacetoxy)ethyl methacrylate (AAEMA), tricyclodecane dimethanol diacrylate (TCCDA), butanediol-mono-acrylate, trimethylolpropanformal acrylate, tripropyleneglycol diacrylate (TPGDA), dipropyleneglycol diacrylate (DPGDA), hexanediol diacrylate (HDDA), isobornyl acrylate (IBOA), neopentylgloycol diacrylate (NPGDA), trimethylolopropan triacrylate (TMPTA), and combinations thereof.

22. The composition of claim 21, wherein the at least one reactive diluent is an alkyl (meth)acrylate selected from the group consisting of methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, n-heptyl (meth)acrylate, n-octyl (meth)acrylate, isooctyl (meth)acrylate, 2-ethylhexyl (meth)acrylate, n-nonyl (meth)acrylate, isononyl (meth)acrylate, decyl (meth)acrylate, lauryl (meth)acrylate, stearyl (meth)acrylate, and combinations thereof.

23. The composition of claim 1, wherein the photoinitiator is selected from the group consisting of include benzophenone, 1-hydroxy-cyclohexyl-phenyl-ketone, 2-hydroxy-1-[4-(2-hydroxyethoxy) phenyl]-2-methyl-1-propanone, 2-hydroxy-2-methyl-1-phenyl-1-propanone, a, α-Dimethoxy-α-phenylacetophenone, 2-benzyl-2-dimethylamino-1-[4-(4-morpholinyl) phenyl]-1-butanone, methyl-benzoyl-formate, Isopropyl-thioxanthone, 2,4,6-trimethyl-benzoyl)-diphenyl phosphine oxide, and phenyl-bis-(2,4,6-trimethylbenzoyl) phosphine oxide.

24. The composition of claim 1 wherein the oligomer is selected from the group consisting of epoxy acrylates, aliphatic urethane acrylates, aromatic urethane acrylates, acrylic acrylates or silicone acrylates.

25. A method of making a photopolymerizable liquid composition comprising:
providing at least one reactive diluent monomer;
dissolving a solid form of a hybridized graft copolymer in the at least one reactive diluent monomer, wherein the hybridized graft copolymer comprises:
(a) a hydrophobic functional polymeric backbone, wherein the backbone comprises (i) an acrylate polymer, an alkylacrylate polymer, a polysiloxane polymer, a polyolefin polymer, a functional polyvinyl polymer, or a mixture of these functionalities, wherein the backbone has an average molecular weight (Mₙ) of from about 3,000 to about 100,000 g/mol; and
b) a plurality of hydrophilic polymeric side chains attached to the hydrophobic functional polymeric backbone, wherein the hydrophilic polymeric side chains comprise a polymerization product of at least one polymerizable unsaturated monomer and a polymerizable amine-containing unsaturated monomer;
optionally adding at least one colorant selected from the group consisting of a dye and a pigment;
optionally adding at least one oligomer; and
optionally adding at least one photoinitiator.

26. The method of claim 1 wherein the solid form of the hybridized graft copolymer is a powder.

27. The method of claim 25 wherein the backbone of the hybridized graft copolymer comprises a hydroxy functional vinyl chloride-vinyl acetate-vinyl alcohol terpolymer portion having an average molecular weight (Mₙ) of from about 3,000 to about 200,000 g/mol.

28. The method of claim 25, wherein the hydrophobic functional polymeric backbone comprises one selected from the group consisting of an acrylate polymer, an alkylacrylate polymer, and both an acrylate polymer and an alkylacrylate polymer having an average molecular weight (Mₙ) of from about 3,000 to about 200,000 g/mol.

29. The method of claim 25, wherein the hydrophobic functional polymeric backbone comprises an alkylacrylate polymer having an average molecular weight (Mₙ) of from about 3,000 to about 200,000 g/mol.

30. The method of claim 25, wherein the hydrophobic functional polymeric backbone comprises an acrylate polymer having an average molecular weight (Mₙ) of from about 3,000 to about 200,000 g/mol.

31. The method of claim 25 wherein the hybridized graft copolymer comprises:
(a) a hydrophobic functional polymeric backbone comprising a hydroxy functional vinyl chloride-vinyl acetate-vinyl alcohol terpolymer portion having an average molecular weight (Mₙ) of from about 15,000 to about 50,000 g/mol; and
(b) a plurality of hydrophilic polymeric side chains reacted onto the hydrophobic functional polymeric backbone, wherein the hydrophilic side chains comprise a reaction product of at least (i) a polymerizable unsaturated monomer selected from the group consisting of: hydroxyethyl acrylate, isobornyl methacrylate, and methyl methacrylate, and (ii) at least one a polymerizable amine-containing unsaturated monomer selected from the group consisting of dimethylaminoethyl methacrylate, and 1-(2-hydroxyethyl)-2-imidazolidinone methacrylate,
wherein the hydrophobic functional polymeric backbone comprises from about 5 weight percent to about 95 weight percent of the hybridized copolymer.

32. The method of claim 25 wherein the hybridized graft copolymer comprises:
(a) a hydrophobic functional polymeric backbone comprising a polymer selected from the group consisting of a hydroxy functional polybutyl acrylate, a hydroxy functional polyethyl hexyl acrylate, a hydroxy functional polyethyl acrylate, a hydroxy functional polymethyl methacrylate, and combinations of two or more thereof having an average molecular weight (Mₙ) of from about 15,000 to about 50,000 g/mol; and
(b) a plurality of hydrophilic polymeric side chains reacted onto the hydrophobic functional polymeric backbone, wherein the hydrophilic side chains comprise a reaction product of at least (i) a polymerizable unsaturated monomer selected from the group consisting of: hydroxyethyl acrylate, isobornyl methacrylate, and methyl methacrylate, and (ii) at least one a polymerizable amine-containing unsaturated monomer selected from the group consisting of dimethylaminoethyl methacrylate, and 1-(2-hydroxyethyl)-2-imidazolidinone methacrylate,
wherein the hydrophobic functional polymeric backbone comprises from about 5 weight percent to about 95 weight percent of the hybridized copolymer.
